(19) United States
(12) Patent Application Publication
(10) Pub. No.: US 2007/0106543 A1
(43) Pub. Date: May 10, 2007

(54) Server-based systems and methods for processing fuel orders

(76) Inventors: Thomas Jason Baughman, Canton, OH (US); James Howard Cundey, Bay Village, OH (US); David Russell Haidle, Elmhurst, IL (US)

Correspondence Address: John V. Biernacki;Jones Day, North Point, 901 Lakeside Avenue, Cleveland, OH, 44114, US

(21) Appl. No.: 11/590,017

(22) Filed: Oct. 31, 2006

Related U.S. Application Data
(63) Continuation of application No. PCT/US05/27951, filed on Aug. 5, 2005.
(60) Provisional application No. 60/616,927, filed on Oct. 7, 2004.

(51) Int. Cl. G06F 9/44

(52) U.S. Cl. 705/7

(57) ABSTRACT

Methods and systems for handling petrochemical fuel orders. A method can include providing, over a network, fuel order data to a vehicle operator's communication device and displaying the received data to the fuel vehicle operator. A system is located at the fuel loading facility and monitors dispensing of fuel from storage into a vehicle. The system sends bill of lading information related to the fuel order. Fuel delivery information is provided from the vehicle operator's communication device. A customer has access over the network to the received bill of lading information and to the received fuel quantity delivered information.

### CROSS-REFERENCE TO RELATED APPLICATION

This application is a continuation of PCT Application Serial No. PCT/US2005/027951 filed Aug. 5, 2005, which claims priority to and the benefit of United States Provisional Application Ser. No. 60/616,927, filed on Oct. 7, 2004, both of which (including any and all figures) are incorporated herein by reference.

### BACKGROUND

This document relates generally to processing fuel orders and more particularly to computer-implemented systems and methods for processing fuel orders.

### SUMMARY

In accordance with the teachings provided herein, systems and methods are provided for handling fuel orders. For example, a system and method can include using a plurality of data interfaces, wherein a first data interface is operable to receive fuel order data from order senders. A database operating on a server is used for storing the fuel order data. Semantic fuel order business rules accessible through a server are used for constructing groups of orders that comprise shifts so that drivers can fulfill orders specified in the stored fuel order data. A second data interface is operable to send fuel order data generated from the server database to a fuel vehicle operator's communication device.

As another example, a system and method can include a plurality of data interfaces, wherein a first data interface is operable to receive fuel order data from order senders. A database operating on a server is used for storing the fuel order data. Semantic fuel order business rules accessible through a server are used for constructing groups of orders that comprise shifts so that drivers can fulfill orders specified in the stored fuel order data. A second data interface is operable to send fuel order data generated from the server database to a fuel vehicle operator's communication device. The fuel order data sent to the fuel vehicle operator's communication device is in a second data format which is a different data format than the first data format. Fuel order processing rules are configured to be operable upon a server to determine whether a discrepancy exists with respect to data received from the communication device and generated as a result of a fuel vehicle operator handling an order specified in the fuel order data or as a result of a fuel vehicle operator inputting information as specified in the fuel order data.

As another example, a signal embodied on a carrier wave can be used that contains a customer order for receipt by a communication device, wherein the customer order is generated according to a method comprising: receiving a plurality of customer orders; wherein customer orders are in different data formats; converting each customer order into a generic data format; sending customer orders to one or more delivery trucks in a data format for handling by a communication device located with a fuel delivery vehicle; wherein the sent customer order information is for display to a fuel truck driver; wherein the generic format is a format that is different than the format in which customer orders are received and different than the format in which data is sent to and received from the communication device; using fuel order processing rules to determine whether a discrepancy exists with respect to data received from the communication device and generated as a result of a fuel vehicle operator handling an order specified in the fuel order data.

As another example, a processor-implemented system can be used for fuel order processing and comprises: means for receiving a plurality of customer orders; wherein customer orders are in different data formats; means for converting each customer order into a generic data format; means for sending customer orders to one or more delivery trucks in a data format for handling by a communication device located with a fuel delivery vehicle; wherein the sent customer order information is for display to a fuel truck driver; wherein the generic format is a format that is different than the format in which customer orders are received and different than the format in which data is sent to and received from the communication device; means for using fuel order processing rules to determine whether a discrepancy exists with respect to data received from the communication device and generated as a result of a fuel vehicle operator handling an order specified in the fuel order data.

Systems and methods disclosed herein may involve data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device. Also computer-readable medium or media may be used to store one or more programs that execute one or more methods disclosed herein.

### BRIEF DESCRIPTION OF THE DRAWINGS

FIG. 1 is a block diagram depicting a computer-implemented system that handles the logistics of picking up from a source and delivering petrochemical fuel to a destination.

FIG. 2 is a process flow diagram that illustrates an example operational scenario.

FIGS. 3-42 depict an operational scenario from the perspective of user interface screens which can be used to interact with a driver at different points in a fuel transportation logistics process.

FIG. 43 is a block diagram that depicts a middleware computer system which enables dispatching to and receiving completion and other data from handheld and Cadec units.

FIG. 44 is a block diagram that depicts an approach that can be used by a middleware computer system to provide security to the information stored in the system.

FIG. 45 is a table that illustrates a functionality security assignment example.

FIG. 46 illustrates preprinted manual data collection stickers.

FIGS. 47-92 illustrate additional examples of operational scenarios that the systems and methods disclosed herein can be configured to handle.

FIG. 93 is a block diagram that depicts different types of networks.

### DETAILED DESCRIPTION

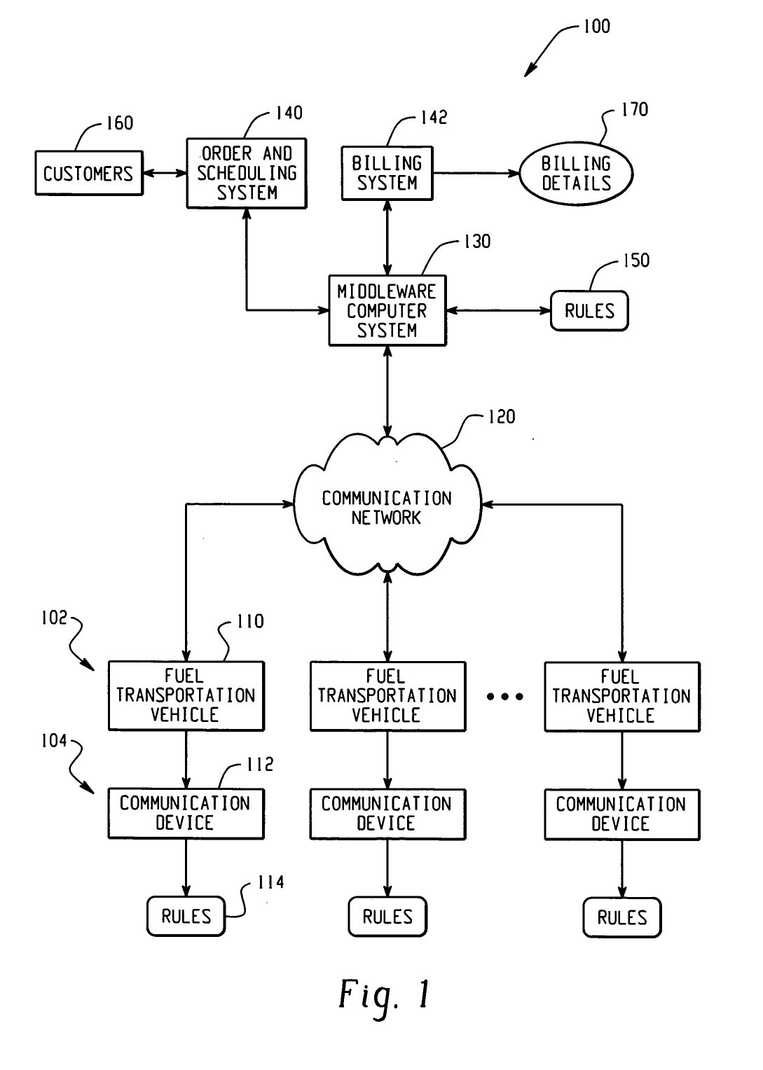

FIG. 1 depicts at 100 a computer-implemented system that handles the logistics of picking up from a source and delivering petrochemical fuel to a destination. Drivers, inter alia, can access order information from their fuel transportation vehicles 102 and pick up fuel per the order. The fuel is then transported and delivered to their destinations. At different points in the fuel transportation logistics process, software operating on communication devices 104 tracks any exceptions in the process. The drivers provide reasons for the exceptions to the communication devices 104.

A truck 110 is equipped with a communication device 112 which contains a human-machine interface so that a driver can interact with the communication device 112. The communication device 112 also contains rules 114 to allow for validating data received in real-time by the driver that relate to the transportation of the ordered fuel.

Many different communication devices 104 can be used, such as, but not limited to, cellular phones and Cadec units. Cellular phones may be selected based upon whether a cellular company provider has coverage at the point where a truck is initially located before picking up loads. As background regarding Cadec units, Cadec units are devices that are available from the Cadec Corporation. Cadec units (and their equivalents) are designed for use with fleets in the commercial trucking industry. Cadec units keep track of truck data (e.g., log data) in real-time for department of transportation (DOT) and other government and legal requirements. It should be understood that many different devices may be used in the vehicles in addition to these mentioned devices.

The communication devices 104 that are provided on the trucks 102 for the drivers communicate over a network 120 with a middleware computer system 130. The middleware computer system 130 provides order information and other data to the drivers through the drivers'0 respective communication devices 104. The middleware computer system 130 also receives information that is generated based upon the interaction between the drivers and their communication devices 104, such as reasons for delay in the pickup/delivery process, gallons (or any other type of fuel amount metric, such as liters) loaded, gallons delivered, customer information, supplier information, accessorial information, etc.

In addition to communicating with the remote communication devices 104, the middleware computer system 130 also interacts with ERP (enterprise resource planning systems), such as an order and scheduling system 140, a billing system 142, etc. The middleware computer system 130 integrates the ordering, scheduling, billing and other ERP processes with the data that is supplied remotely through the driver in the field in real-time or in near real-time. Because the middleware computer system 130 stores comprehensive data regarding the transportation order, payroll systems can use the stored data to handle its payroll operations.

The middleware computer system 130 also contains rules 150 to identify data mismatches, such as when sum of the gross gallons entered by the driver does not match the gross gallon figure specified by the bill of lading. The rules 150 also help, inter alia, with such integrity checking as to ensure the integrity of the bills sent to customers.

The rules 150 of the middleware computer system 130 and the communication devices 104 can be used to ensure that a driver is processing the order in the manner prescribed by the scheduling system 140. A communication device 112 collects the actual logistics data to help determine whether the actual logistics-related data mirrors the planned logistics-related data. As an illustration, a communication device 112 can include or have access to a global positioning satellite (GPS) location system in order to ascertain the real-time position of the driver's vehicle 110. This information can be used to determine whether the driver is in compliance or substantial compliance based upon whether the current location of the vehicle 110 matches the location expected in the scheduling instructions.

The rules 150 of the middleware computer system 130 and communication devices 104 can be dynamically updated to reflect changes in validation requirements, such as when a customer 160 imposes a new billing validation requirement which may cause a change in the rules 150 of the middleware computer system 130. It is noted that the middleware's billing validation requirements help reduce the costly number of errors that can occur with the generation of bills 170 sent to the customers 160.

To the extent that a communication device 112 can validate a driver's input via its rules 114, it can be configured to do so. However to the extent that a middleware computer system 130 can validate the driver's input, it can be configured to do so via its own rules. For example if a communication device 112 cannot validate the driver's input because the communication device 112 does not have sufficient information to do such validation, a middleware computer system 130 can perform the validation because of its access to a greater amount of information related to the driver's order.

A system from an overall perspective can be configured such that the validation process is pushed where possible to the communication device level so that validation can be performed locally. This allows validation to occur even though the driver may be within a communication blind spot and may not be able to communicate with a middleware computer system 130. As an illustration if a driver indicates to the driver's communication device 112 that 150 gallons of fuel were loaded but the order actually required that two hundred gallons be loaded, then the communication device 112 would determine that an invalid condition existed and would ask the driver to either supply a corrected amount of gallons or ask the driver for a reason for the discrepancy. If the communication device 112 is in communications with a middleware computer system 130, then the communication device 112 would relay this information in real-time (or near real-time) to the middleware computer system 130. However if the communication device 112 is not in communications with the middleware computer system 130, then the communication device 112 would store this information collected from the driver so that the information can be forwarded later to the middleware computer system 130 when communication has been restored. This allows the driver to continue to fulfill the order and not have to wait for validation or confirmation from a remote host system (e.g., a middleware computer system 130). Accordingly in this example, exceptions and other data integrity issues can be handled locally at the truck level and in a communications independent manner since the checking is performed by the communication device 112. Overall, the communication device 112 can be configured to capture enough information so that a complete picture of the handling of the order by the driver can be ascertained when the data is ultimately communicated to the middleware computer system 130.

The use of a middleware computer system 130 allows disparate other software products to be utilized with the system, including third-party ERP software products (as well as a variety of scheduling order systems) which may use different data formats and communication protocols. A middleware computer system 130 can acquire information from these disparate systems (e.g., systems 140, 142, etc.) as well as acquire data from truck drivers via their communication devices 112. Although the different systems and communication devices 112 may utilize different data formats and/or protocols, a middleware computer system 130 can acquire the different systems'0 and devices'0 information and process it into a standardized format for access by the different ERP software systems and vehicle communication devices 112.

Fuel transportation logistics information in this standardized format information allows the information to more freely be utilized by the disparate systems and communication devices 112. In this sense, a middleware computer system 130 provides a type of lingua franca by which the other systems as well as the communication devices 104 can utilize each others'0 information to more efficiently and effectively handle fuel transportation requests without having to be concerned with each others'0 unique communication and data handling requirements. For example if a new customer 160 arises with its own unique order data. transmission system, a middleware computer system 130 can interact with the new customer's system and store the data in a generic and common framework so that other systems (e.g., the ERP systems and communication devices 104) can access the data without having to understand the details of communicating with the new customer's system.

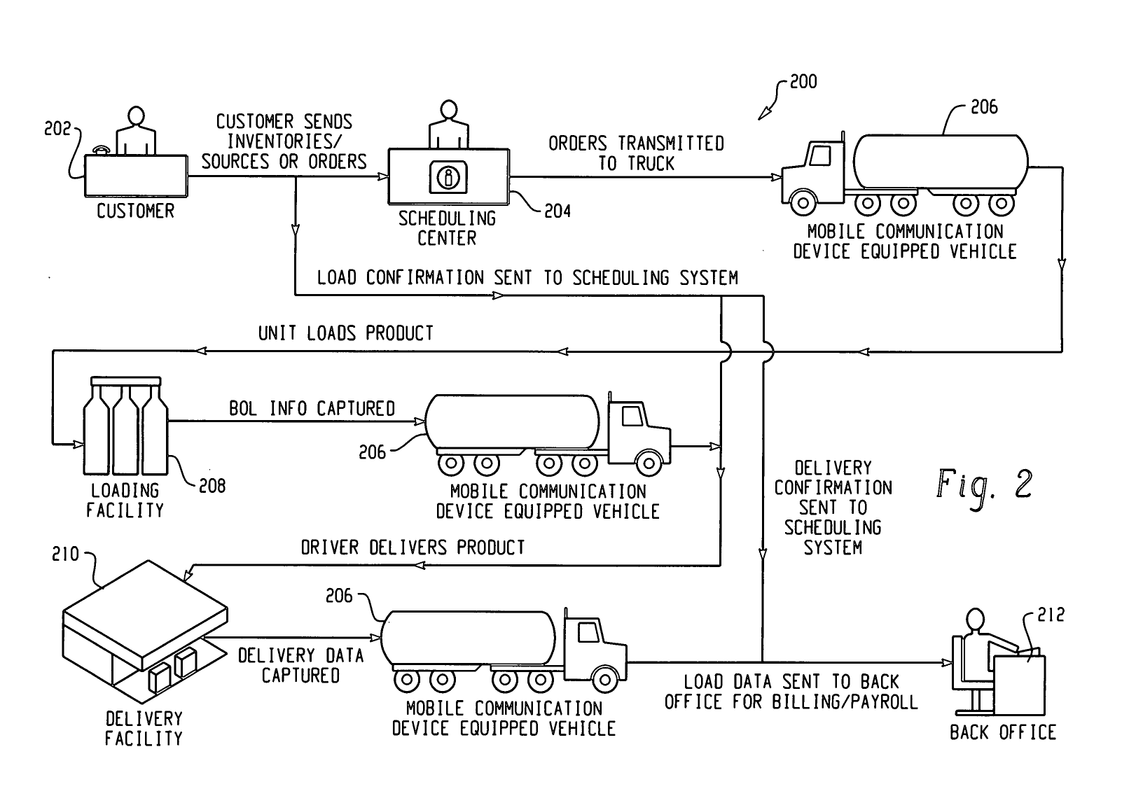

FIG. 2 depicts at 200 a process flow diagram that illustrates an example operational scenario. In this operational scenario, a customer 202 sends inventories/sources or orders to a scheduling center 204. The scheduling center 204 determines how to efficiently process the customer's order and may use a third party technology, such as the Aspen Scheduling System, to perform scheduling. The scheduler can use optimization techniques to ensure that the order is handled efficiently (e.g., being assigned to the proper truck and in the proper order relative to other fuel delivery requests that the truck driver has to fulfill).

After the scheduling center 204 has determined an optimal way to handle the orders, the orders are forwarded by the middleware computer system to the trucks (e.g., truck 206) assigned by the scheduling center 204 to handle the orders. To handle his/her respective order, a truck driver utilizes the communication device to receive the order and in the manner specified by the scheduling center 204.

The driver proceeds to the specified loading facility 208 in order to transfer the required fuel from the loading facility to the truck. Bill of lading information is entered into the driver's communication device by the driver, the driver delivers the product to the delivery facility 210, and the driver enters the actual delivered information into the communication device. The end-to-end delivery data is captured by the communication device and forwarded back to the middleware computer system. A back office 212 can receive the captured information. Such data provided to the middleware computer system includes, but is not limited to, delivery confirmation information being sent to the scheduling system as well as load data being sent to a location for handling billing and payroll operations.

It should be understood that similar to the other processing flows described herein, the steps and the order of the steps in the flow may be altered, modified, deleted and/or augmented and still achieve the desired outcome.

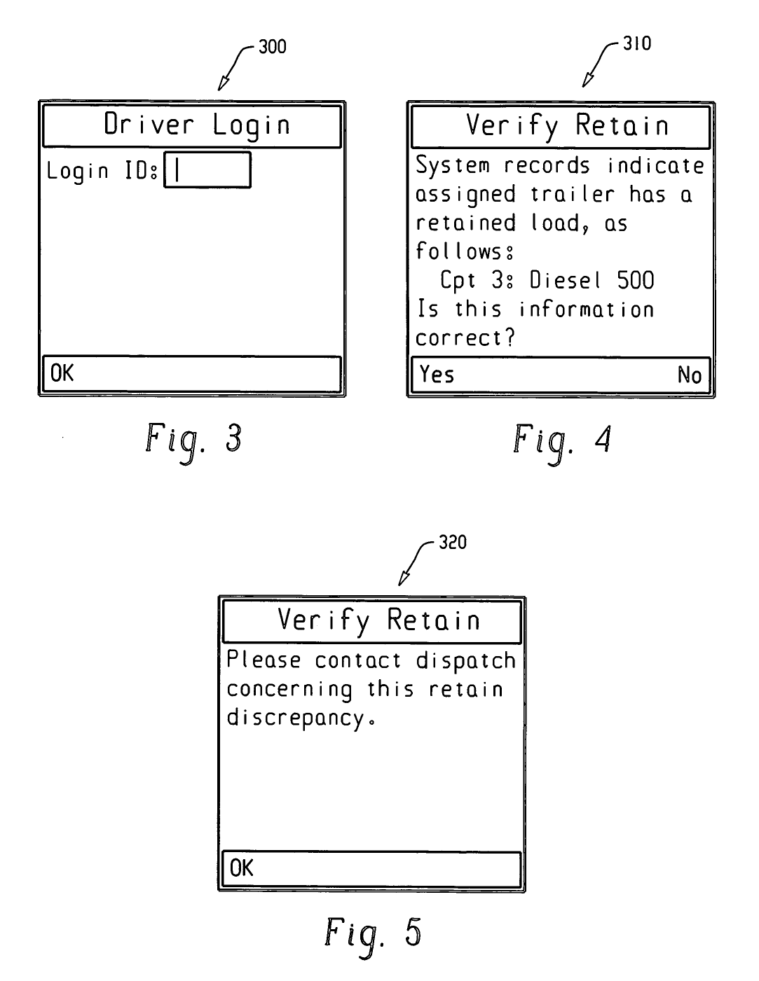

FIGS. 3-42 depict an operational scenario from the perspective of user interface screens which can be used to interact with a driver at different points in the fuel transportation logistics process. More specifically, the user interface screens depict an operational scenario wherein drivers receive and provide fuel load and delivery data to a communication device. The data can be communicated to a middleware computer system over a network in real-time or near real-time, provided that the communication device that is being utilized by the driver is within a geographical region that allows for the communications over the network to occur (e.g., the driver is not in a “blind” communication location).

FIG. 3 depicts at 300 an interface screen for use by drivers operating the fuel transportation vehicles. The screen allows driver login and carrier login. Validation is performed to ensure that a driver can only access his/her orders. After a successful login, a vehicle operator can view the operator's orders.

FIG. 4 depicts at 310 an interface screen wherein each time a driver logs in the application, a check is performed to determine whether the previous driver of the vehicle had delivered all of the previous order. If a fuel retain is recorded on board from the previous shift, the interface screen of FIG. 4 appears. The driver can acknowledge this by pressing the “Yes” button on the interface screen.

If the driver disagrees with the retain amount shown on the interface screen of FIG. 4, the driver can select “No” and the interface screen of FIG. 5 appears (as shown at 320) in order to provide information to the driver on how to handle the retain discrepancy.

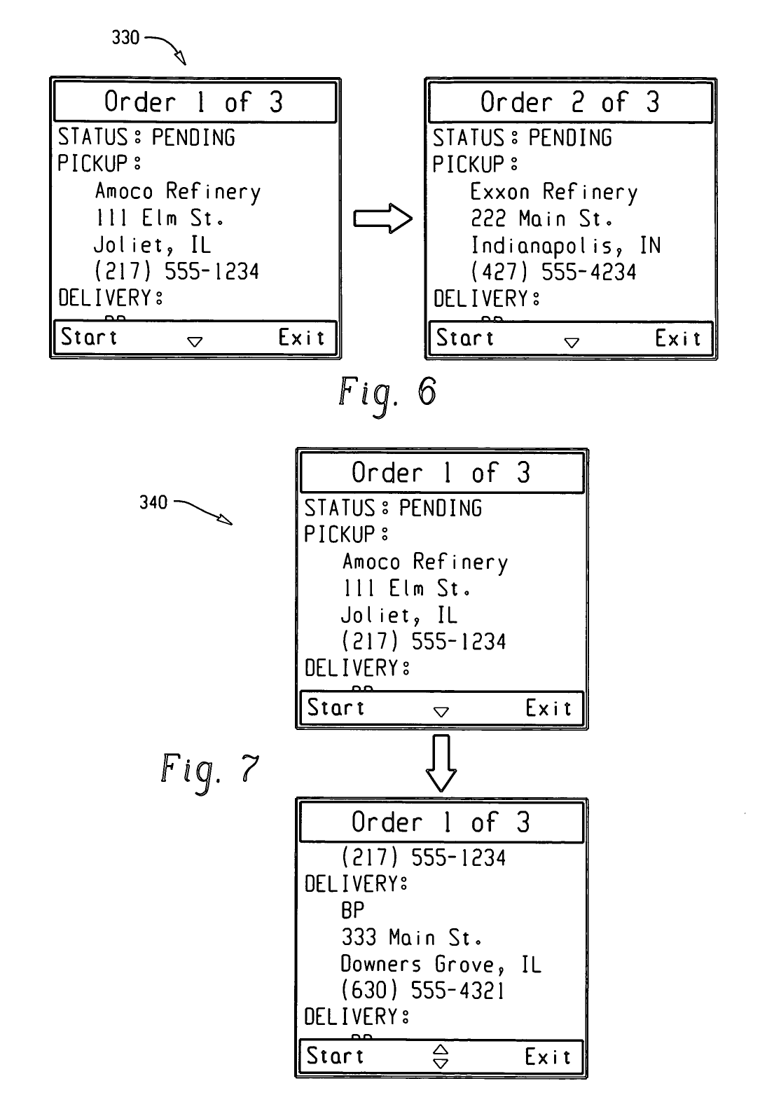

If there is no retain onboard, or a retain has been acknowledged by the driver, the driver can access fuel transportation trip data associated with one or more orders for the driver. FIG. 6 depicts at 330 an interface screen that allows the driver to scroll through the orders received. A system can be configured such that the driver could have access to see the orders but not change the sequence. In this case the start option would only be enabled on the first order.

FIG. 7 depicts at 340 an interface screen wherein a driver can use the down arrow on the display device to show him/her the details of an individual order.

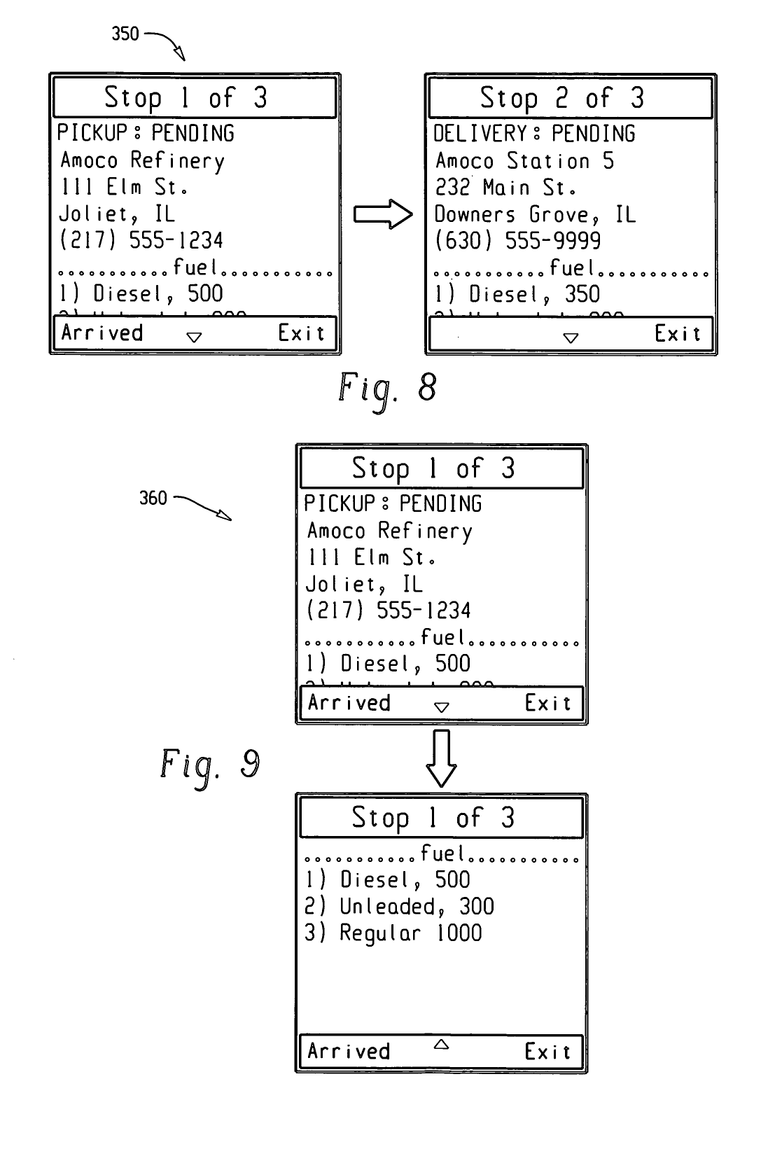

FIG. 8 depicts at 350 an interface screen wherein after the driver selects the “Start” option for a load, he/she will be allowed to scroll left-to-right to see the detail by stop. Loading and unloading events are considered stops. The driver can also select the “Exit” option to return to the previous screen.

FIG. 9 depicts at 360 an interface screen wherein a driver may need to scroll down on any stop to see all of the detail.

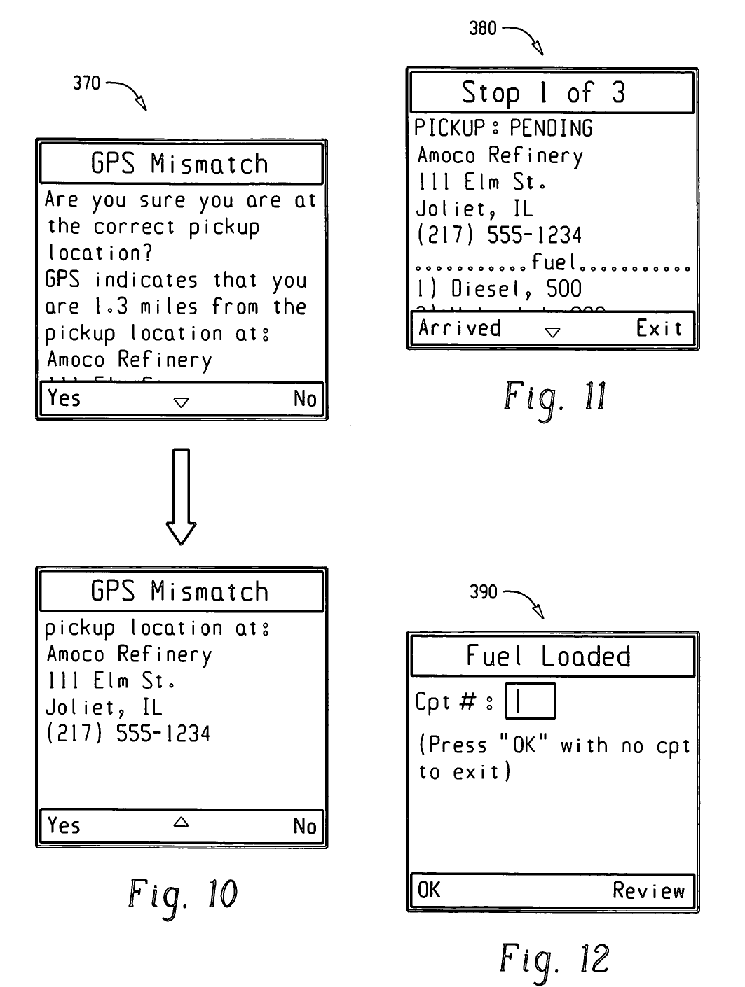

When the driver selects the “Arrived” option the system compares the current latitude-longitude to the expected latitude-longitude. If they differ, the driver gets the message displayed at 370 on FIG. 10. If the driver selects “Yes” the actual latitude-longitude will be recorded and returned to the server. If the driver selects “No,” it is the same as cancel.

FIG. 11 depicts at 380 an interface screen wherein a driver can indicate to the device that the driver has reached a destination. The driver provides the indication by selecting “Arrived” on the interface screen. This selection precipitates the compartment screen shown on FIG. 12.

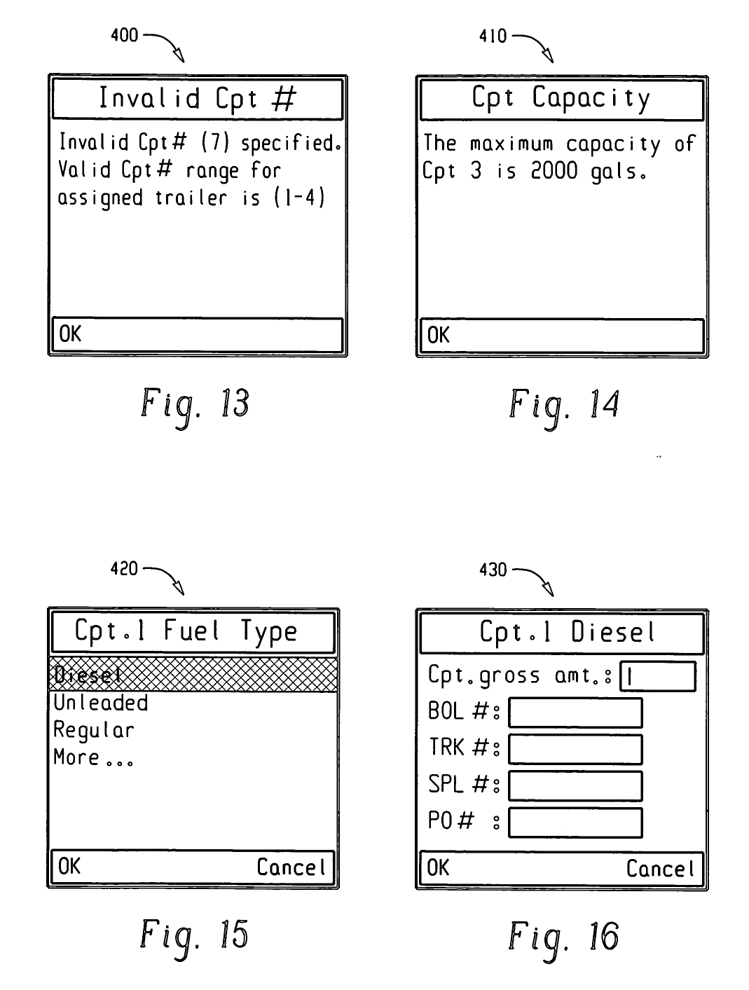

The system in this example is capable of receiving orders by compartment or aggregated by product, and FIG. 12 depicts at 390 an interface screen wherein a driver is asked to enter gross gallons by compartment. If the trailer configuration is passed with the order, validation will occur. For example, if the driver entered compartment number 7 when the trailer only has only 4 compartments, then the application will display the message as shown at 400 in FIG. 13. The application on the driver's device can also be configured to validate other operational aspects. For example, if a driver enters 2,500 gallons in a compartment that has a maximum capacity of 2,000 gallons, then the system can be configured to display to the driver the message shown at 410 in FIG. 14.

If the order includes compartment data, then the driver can be shown a list such as the one displayed at 420 in FIG. 15. The list can be configured such that the list only includes the product expected to be placed in that compartment. If the driver was loading a product not included in the order, the driver could select “More” and a default list of the products would be shown for him/her to select from.

FIG. 16 depicts at 430 an interface screen which is displayed to the driver after the driver has indicated the product via the interface screen of FIG. 15. In the interface screen of FIG. 16, the driver is asked to enter the gross gallons in the gross amount field that were loaded in that compartment. The driver also enters: the BOL# which is the loading rack's unique number from the bill of lading; the TRK# which is a unique bar-coded number adhered to the bill of lading (the TRK# can also be used to link the imaged physical bill of lading to this order); the SPL# which is the supplier of the product; the PO# which is a customer reference number that may be required. Validation can be performed on user entered data, such as the SPL# data.

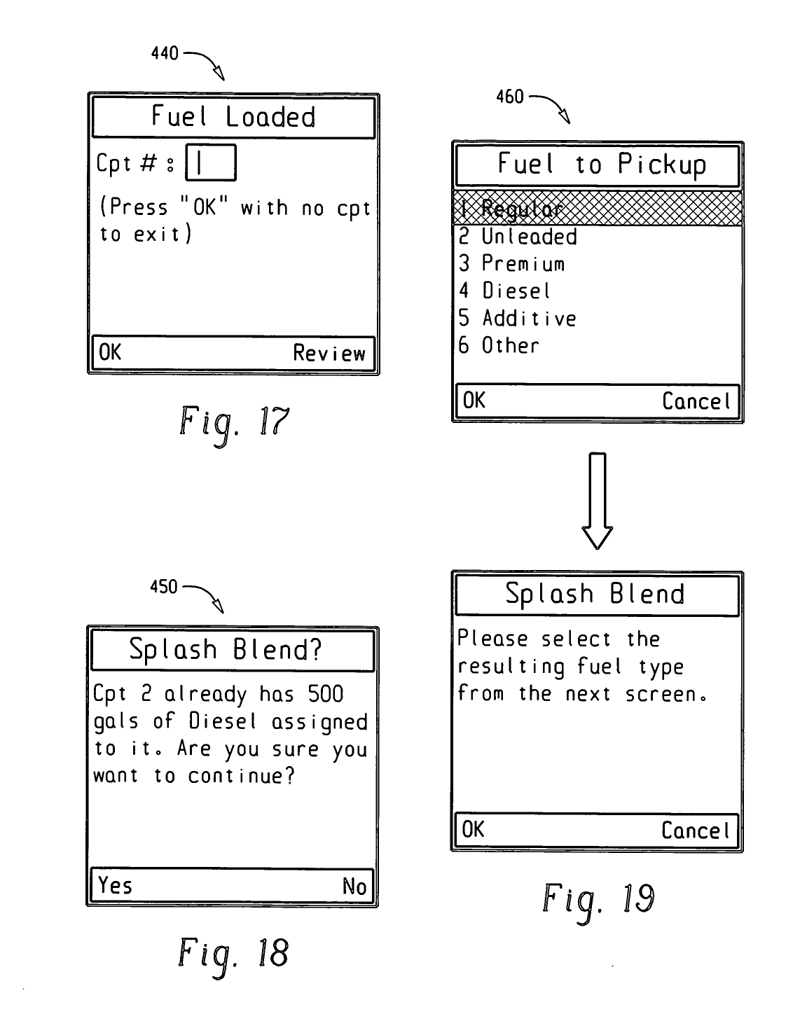

FIG. 17 depicts at 440 an interface screen wherein when the driver enters information for a compartment, the driver will be brought back to this screen to add additional compartment information.

If the driver enters a compartment number for the second time, the system will show the message displayed at 450 in FIG. 18. If the driver selects “Yes,” a default list of products is shown.

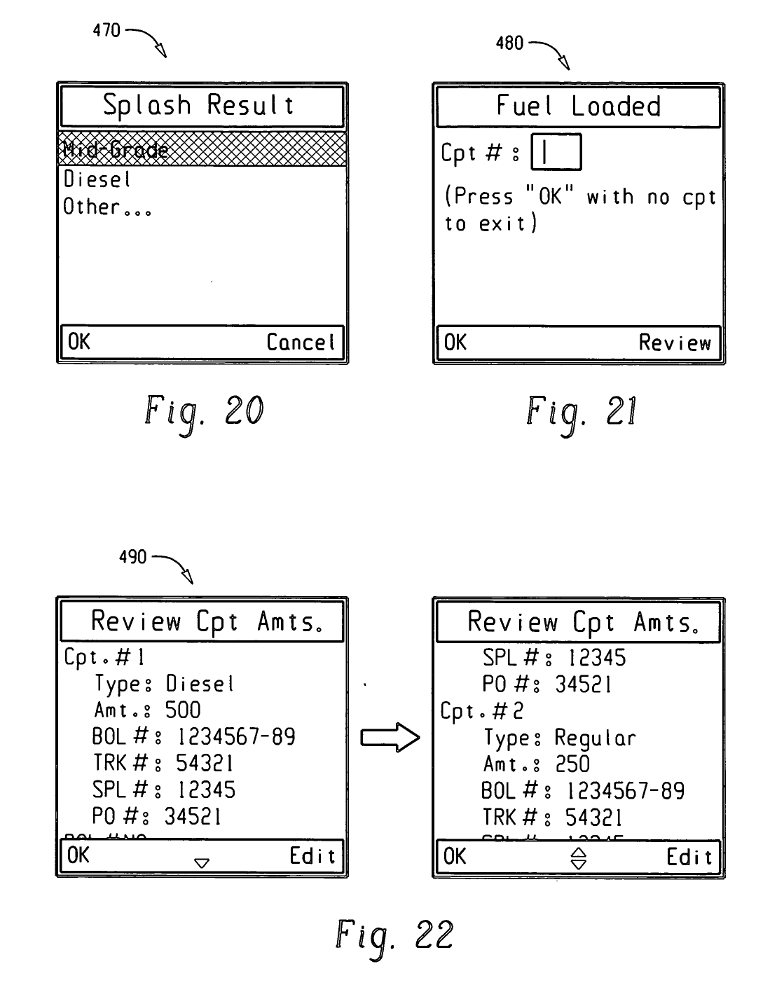

The driver selects the product and enters the loading information via the interface shown at 460 at the top of FIG. 19. When the driver has completed the data entry, the screen on the bottom of FIG. 19 is displayed for user input. Then, a screen as shown at 470 in FIG. 20 is displayed to the driver with a list of the products from the order and asks the driver what he/she has created (e.g., mid-grade).

When the driver has entered all compartment information, he/she can select the “Review” on the interface screen shown at 480 of FIG. 21. If the “review” option has been selected, then the interface screen shown at 490 of FIG. 22 is displayed to the user wherein the driver can scroll through all of the compartment data. If there is a problem, the driver can select the “Edit” option in order to scroll through all of the compartment data again. The BOL#, TRK#, SPL# and PO# fields captured for the first compartment will repeat for all others loaded as illustrated in FIG. 22. The driver can however overwrite any of the fields.

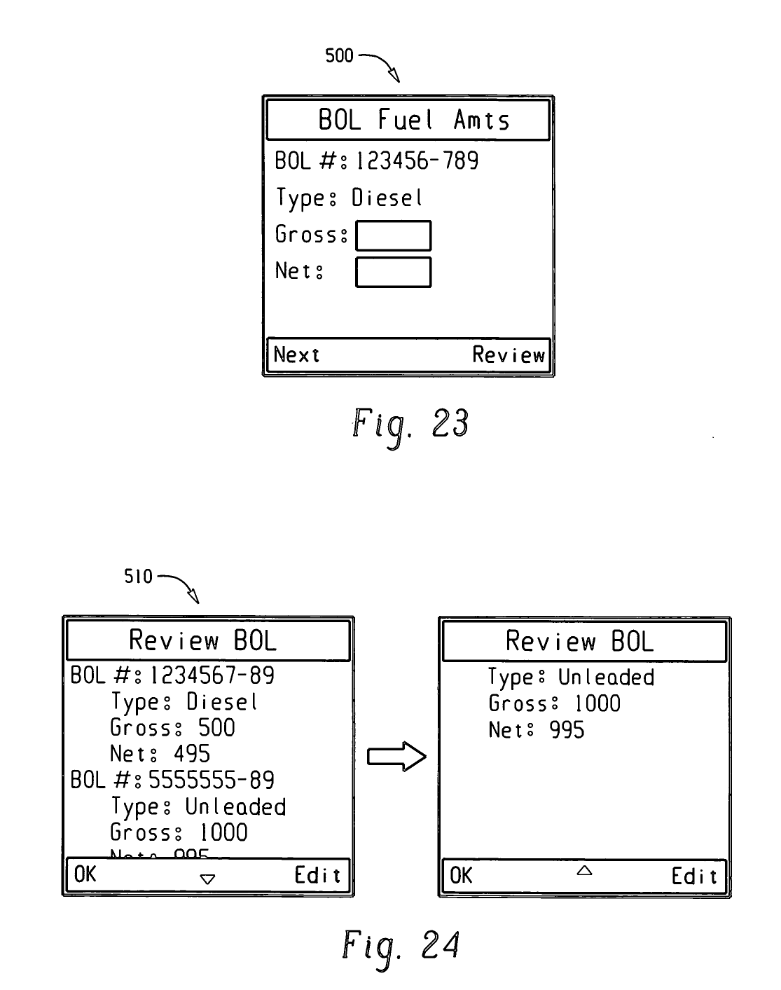

As shown at 500 in FIG. 23, when the driver completes his/her review, the driver is asked for BOL information. A system may be configured such that each combination of BOL# and product may require entry of both gross and net gallons.

FIG. 24 depicts at 510 an interface screen wherein the driver has the option to select “Edit” to modify the data or select “Ok.” When “Ok” is selected, the system does a validity check based on the total gallons by product entered in the compartment entry vs. the BOL gallons by product.

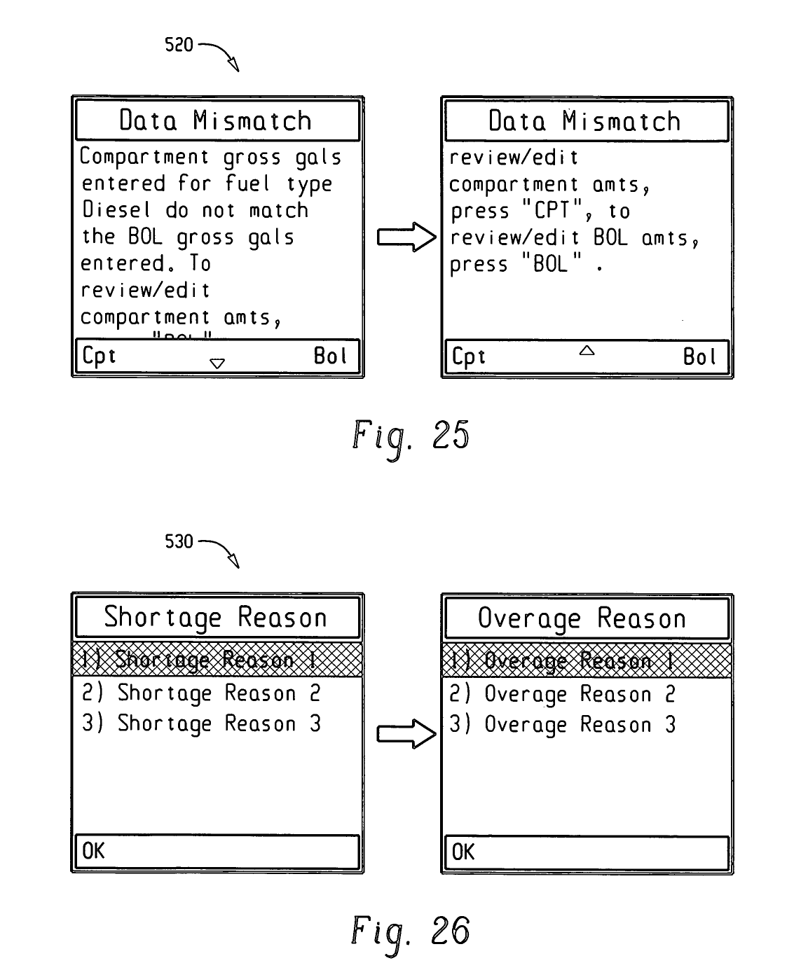

If the gross gallons of a product entered in the BOL screen do not match the gross gallons entered in the compartment screen the driver see the message displayed at 520 in FIG. 25. From here, the driver needs to fix the problem before continuing.

On the interface screen of FIG. 25, the “Cpt” option takes the driver to the compartment edit screens while the “Bol” option takes the driver to the BOL edit screens. The system may be configured such that the driver must correct the problem before continuing.

When the compartment data and the BOL data match, a validation is performed against the order. If there is a variance of more than a pre-selected amount (e.g., 50 gallons), one of the messages shown at 530 in FIG. 26 appears. The driver can then select an appropriate reason. “Other” can also be provided so that it can be kicked out as an exception.

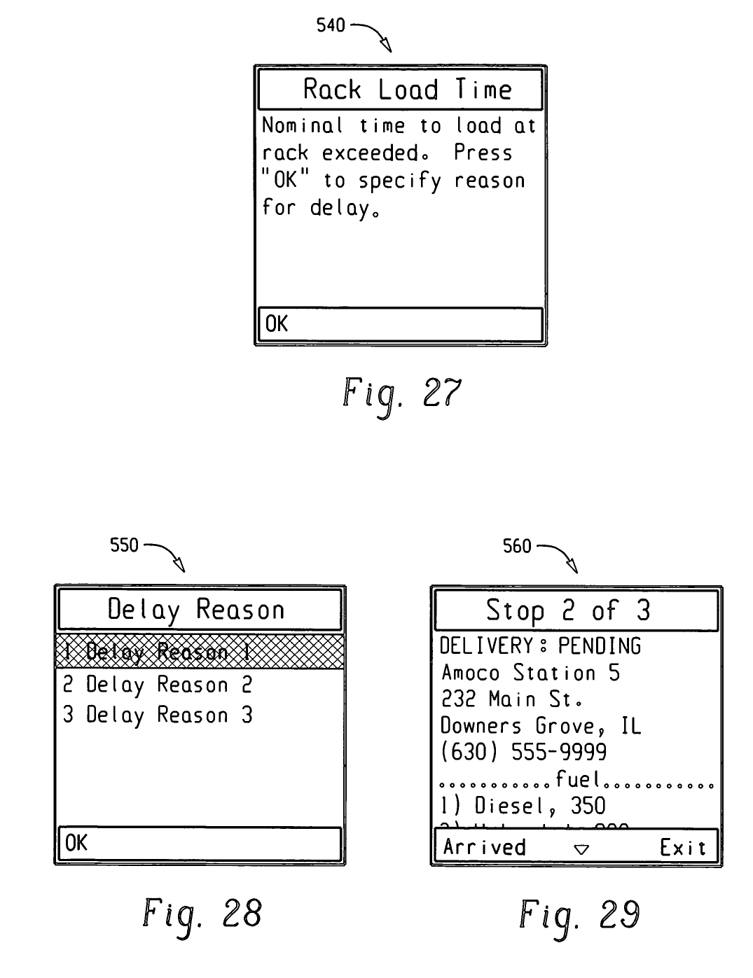

When the driver provides an indication to the system that the driver has arrived as the driver enters the loading rack, a timer is started. When the driver completes the loading information the timer stops and the elapsed time is compared to a standard (e.g., a time elapsed criterion). If the standard is exceeded the driver sees the interface screen shown at 540 of FIG. 27. Drivers can be asked if there is a delay, and the driver can provide a reason. Depending upon the delay, a company may be able to bill the customer for the delay as may be established by a contract between the company and the customer. The middleware computer system can contain rules based upon the contract to determine whether the customer can be billed for the delay. Drivers can be provided with one or more pre-determined reasons for an exception, such as a delay, from which the driver can select the most appropriate reason and/or drivers can manually enter textual exception reasons.

When the driver selects “Ok” from the screen of FIG. 27, the driver is asked for a reason for the delay. As shown at 550 in FIG. 28, a driver can select a reason code, and the application is done with the loading phase for that stop.

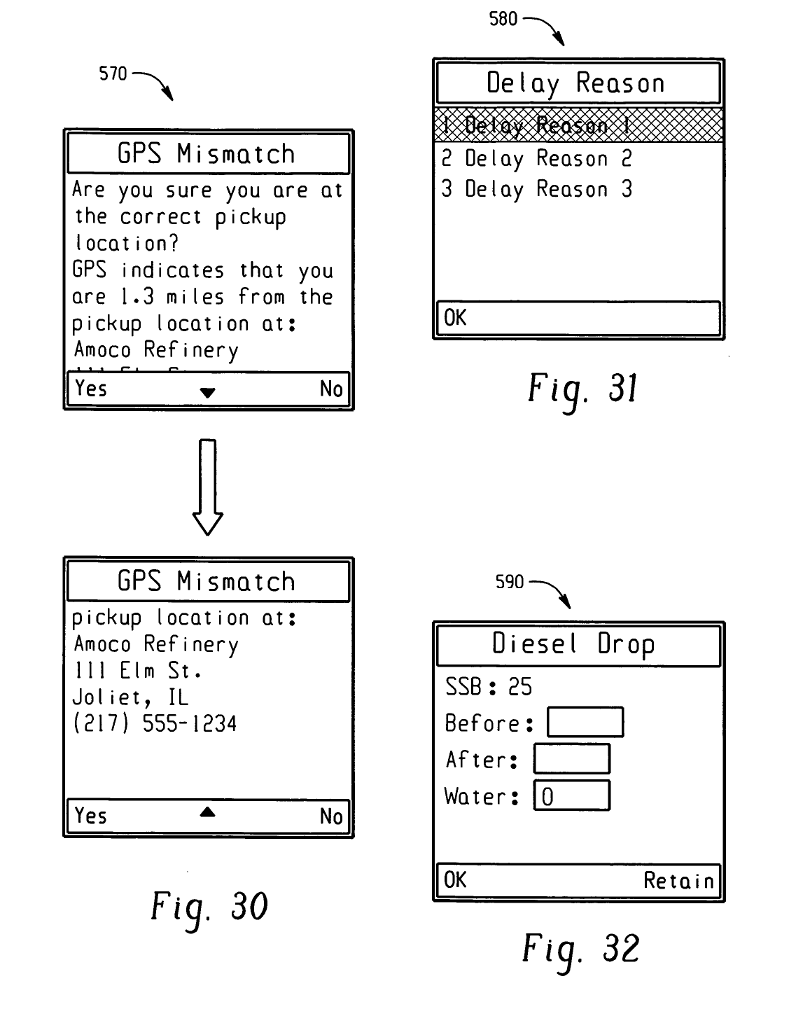

Until the driver arrives at the next stop, the interface (e.g., as shown at 560 in FIG. 29) indicates that the delivery is still pending. When the driver arrives at his/her next stop the driver selects the “Arrived” option. The system then compares the current latitude-longitude to the expected latitude-longitude. If they differ by a predetermined amount, the driver receives the message shown at 570 in FIG. 30. If the driver selects “Yes” the actual latitude-longitude is recorded and returned to the server. If the driver selects “No,” then the mismatch dialog box is canceled. When the driver completes his/her last stop, a fresh timer is started in order to capture the elapsed driving time. When the “Arrived” option is selected, the system checks the elapsed time against the trip standard and if the standard is exceeded the driver is asked for a reason code as shown at 580 in FIG. 31.

As shown at 590 in FIG. 32, the system is set to allow the order origination system to pass a stick value which should be a predetermined SSB level. This is the level in inches that the stick reading needs to be below in order to safely deliver the loaded gallons in this tank.

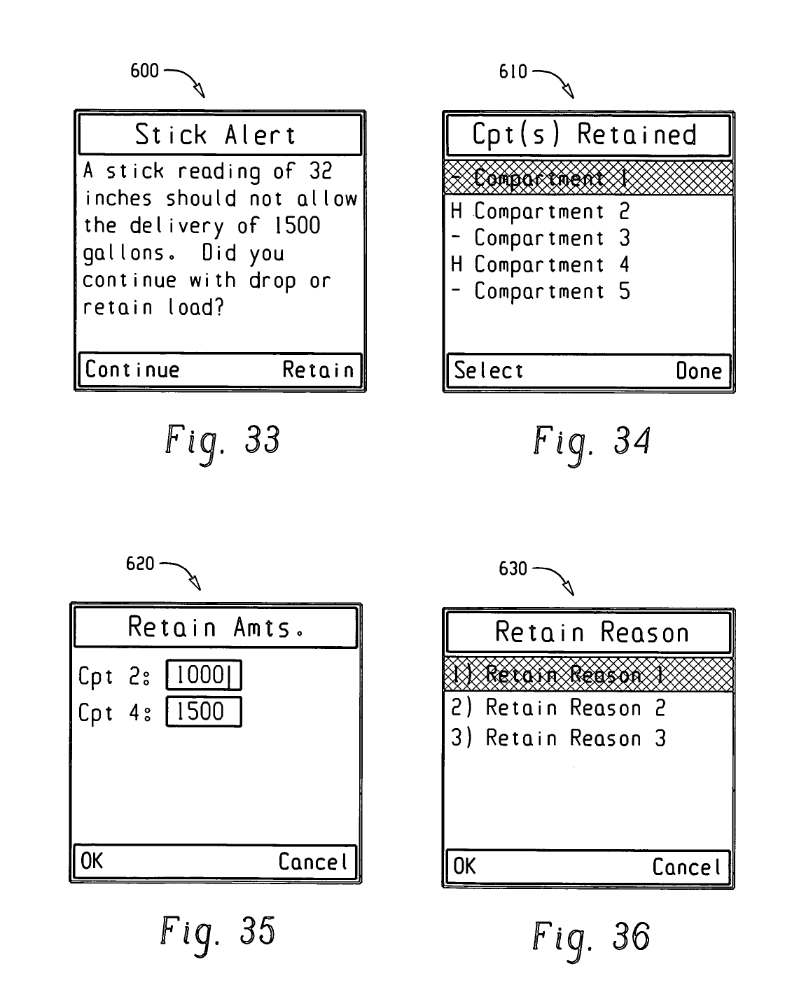

The interface screen of FIG. 32 appears when the driver selects the “Arrived” option. If the SSB functionality is not desired, the driver can use his/her tank charts to identify if there is room for the product. The driver may enter by product or by tank the stick reading for each product in inches. If the SSB is being sent with the order, the system will validate whether the starting stick reading is below the SSB. If not, the driver receives the message as-shown at 600 in FIG. 33. If the driver selects the “Continue” option, a note is recorded tobe sent back to the host system and the process continues. If the driver selects the “Retain” option, a retain process is initiated as shown in FIG. 34.

FIG. 34 depicts at 610 an interface screen wherein the only compartments shown are the compartments that were loaded with that product. The driver selects the compartment or compartments that were not delivered. FIG. 35 depicts at 620 an interface screen wherein after selecting the compartments that were not delivered in full, the driver is shown the gallons that were loaded in those compartments. If they are unbroken, the driver selects “Ok.” If the compartments have been broken, the driver is asked for an estimated number of gallons still onboard.

FIG. 36 depicts at 630 an interface screen wherein after the driver selects “Ok” from the previous screen, the driver is asked for a reason for the retain. From this point on, the system knows that the retained product has not been removed from the trailer. The system is set to allow the retained gallons to ride on the trailer until delivered. The retained gallons can be delivered through an ad hoc delivery. A record for each compartment is written so that the compartment can be delivered before returning to the rack or this compartment can be top-loaded and delivered with the next order or a successive order. When the retain is finally delivered, the record is amended to include the order number it was delivered with as well as a second bill of lading depending on how the loading facility handled the order.

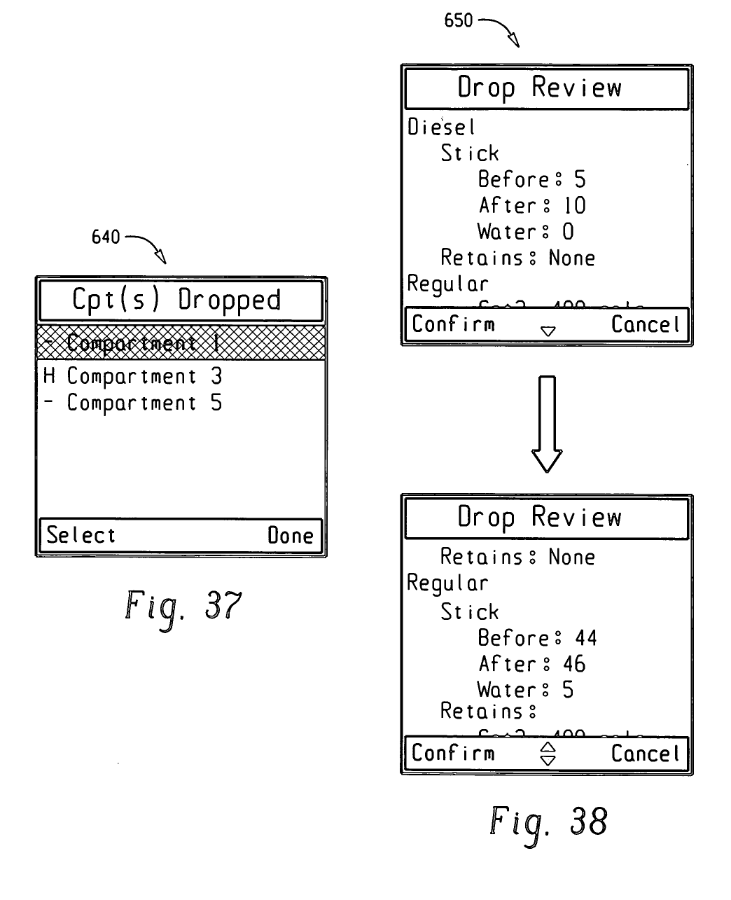

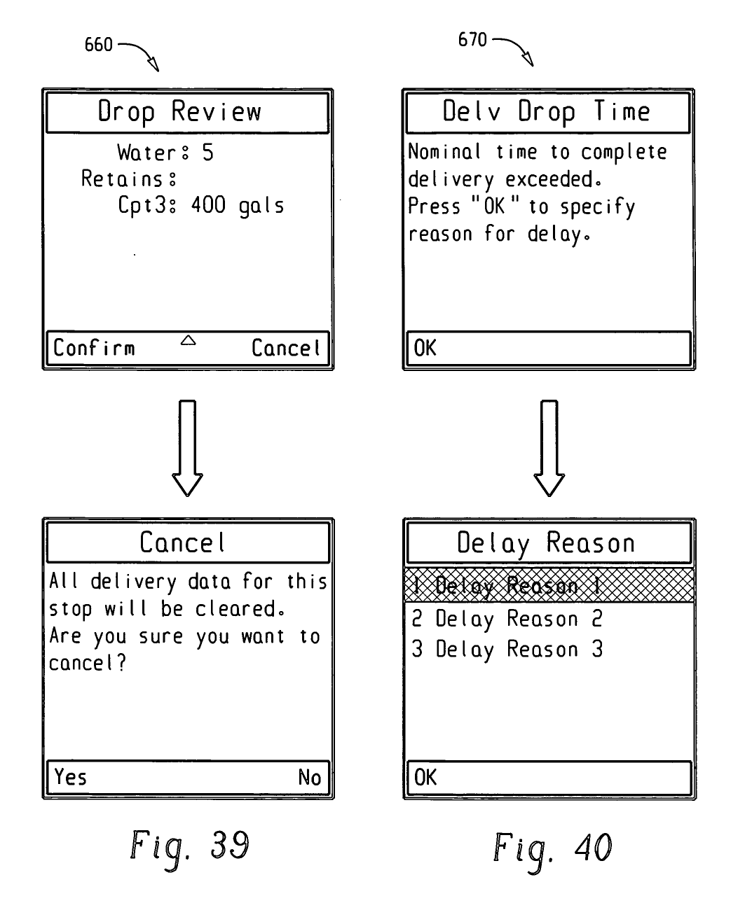

If there is not a retain after the driver enters the stick readings, a list of compartments that were loaded with product is shown at 640 in the interface screen of FIG. 37. The driver selects the compartments dropped and selects “Done.” The process of stick readings and dropped products continues until there are none left. As shown at 650 in FIG. 38, the driver has the option to review the data he/she entered during the drop review. If the driver selects “Cancel” during the review, the interface screen as shown at 660 in FIG. 39 appears. If the driver selects the “Confirm” option, the elapsed time from “Arrived” is calculated and compared to the standard.

If the standard is exceeded, the driver sees the interface screen depicted at 670 in FIG. 40 and is asked for a reason for the standard being exceeded. If time was not exceeded or when a reason has been selected, a new timer starts and runs until the driver returns to the rack where the time exceeded logic is repeated.

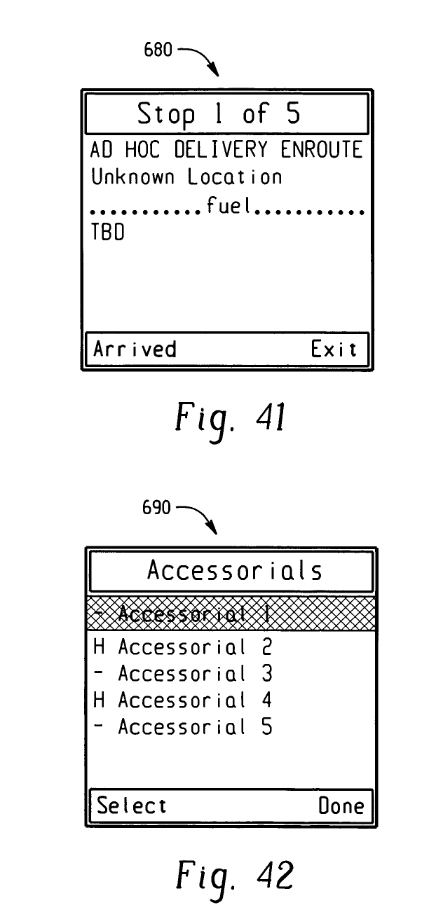

If a compartment has been retained after unloading at a delivery, the driver can follow the retain process explained above and complete that stop. If there are more stops on the order, the driver can deliver the retained product to any of those stops. If the retain was the only stop or the last stop, the driver can drive to any other delivery location to drop the retained product and indicate this to the system via the interface screen shown at 680 in FIG. 41. The interface screen allows the driver to select “Arrived,” and the system then obtain a latitude-longitude and allows the driver to continue with the regular delivery process. The actual latitude-longitude can be compared to a customer master file to identify the actual delivery location. The system can be configured to write a detailed record as to: when and where the product was loaded; all of the orders that compartment traveled with and when; and where it was physically delivered. The driver can also access the system to see a list of accessorial charges as shown at 690 in FIG. 42 and select one or more to be added to the record that is sent back to the host system.

At any time from the menu, the driver can select the “End of Shift” option. If the driver selects an “End of Shift” option and if there are no loads on the client, the system writes a latitude-longitude and sends a record to the host system. If there are loads on the client when the driver selects “End of Shift,” the driver is asked to confirm that this is what they want to do and then a record is sent back to the host identifying that the driver has ended early and the orders that were not completed or delivered. If there are any products left on the trailer, the system sets the retain on board flag.

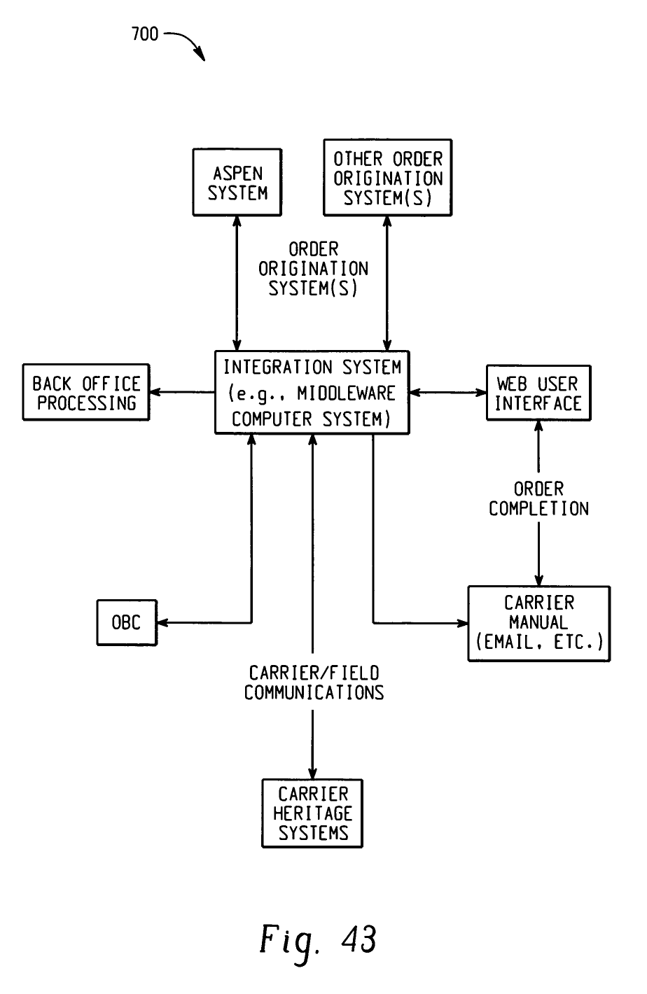

The mobile communication device can communicate with a host server system, such as the middleware server system shown at 700 in FIG. 43. FIG. 43 depicts a middleware computer system which enables dispatching to and receiving completion and other data from handheld and Cadec units (e.g., communication devices) that are used by drivers of delivery vehicles. The handheld and Cadec units provide an interface between drivers and the middleware computer system.

The middleware computer system shown in FIG. 43 serves as a conduit between order origination systems and the drivers who perform fulfillment on the orders. The middleware computer system can be extended to act as an interface between upstream systems and the drivers'0 communication devices as well as monitoring the communication devices in near real-time fashion.

The middleware computer system can handle orders that do not originate from a mobile device unit, such as those that originate from other systems (e.g., web-based systems). The middleware computer system allows authorized users to manually enter and correct Order Completion data for Assigned Deliveries that are not yet completed. A user may change completion data. Updates can be validated with the same rules as those that apply to the original completion data.

For split/multi-consignee loads, the middleware computer system matches the Station Number for each Consignee to identify the associated Assigned Delivery number. In the event that the same station (e.g., consignee) occurs on more than one Assigned Delivery on a given Load, the middleware computer system can be configured to not automatically accept the Order Completion data for this load. Each consignee identified in the Order Completion data should in this example correspond to one and only one Assigned Delivery. If this validation fails, the order completion data for the entire Load is placed “in suspense” for manual correction (e.g., a user can manually link an emergency order to another load to satisfy linkage for a diverted load).

The middleware computer system may support receiving odometer readings furnished by a communication device and use the readings to calculate the distance traveled for each Load and the total distance traveled during a Shift. Furthermore, the middleware computer system can store facility maps and make them available to drivers. Maps can be stored for Station (uploading Facility), Terminal (Loading Facility), Domicile (Truck Domicile, other company structures), and Highway (Intersection/Interchange or other road-related). Maps can be uploaded to the middleware computer system by users via a Web UI.

The middleware computer system can accept order completion data for assigned deliveries via automated interfaces from downstream carrier systems. Completion data is inserted into the middleware computer system's database. The middleware computer system continually scans the database for updates to assigned deliveries.

The middleware computer system supports receiving updated GEO data for Stations and Terminals. Where new GEO data is received in an ERP system, that information is forwarded to the middleware computer system.

The middleware computer system validates order completion information. Validation for orders includes checks for required fields, valid field types, etc. Specific validation (or reasonableness checks) can be enforced for an order based on the specific Customer or Order Scheduling System. The middleware computer system validates the components in composite products delivered against standard component mix formulas. When Order Completion data does not pass validation, the middleware computer system keeps it in Suspense until it is manually corrected to satisfy validation.

As another validation example, the middleware computer system can relax planned vs. actual retain rules, such as when dealing with a retain situation and the retain discrepancy is due to a customer problem.

The middleware computer system monitors the communication devices and communicates events and statuses relative to the communication device interface to appropriate personnel. The middleware system watches for Accept/Reject of Dispatches from remote units. The middleware computer system monitors the communication devices and logs an event if a driver rejects a dispatch, whether it is for a full Shift or for a single Load. The middleware computer system monitors the communication devices and logs an event if a driver rejects a request for a change to a Load or a request to cancel a Load.

The middleware computer system watches for delays and abandoned/incomplete loads. For example, the middleware computer system can use the scheduled delivery times (ETA) to calculate when a Load should be completed and will log an event if a predetermined amount of time has elapsed without work having begun on the Load. The middleware computer system can use the shift start and end times to determine when a driver should log in, and if a predetermined time has passed without a driver login, the middieware computer system will log an event. The middleware computer system may use the ETA times for each Load to calculate whether or not a driver is on schedule for his Loads. If there is more than a predetermined amount of variance between planned delivery times and actual delivery times, the middleware computer system will log an event. The middleware computer system can be configured to log an event if a driver ends his shift without completing all Loads assigned to the Shift. The logged event indicates which Loads are incomplete.

The middleware computer system can be enabled to provide alerts for events specific to a communication device, such as a request to modify a Load was rejected or a request to cancel a Load was rejected. Other events may include, but are not limited to: Driver declined Load; Driver finished shift before all Loads were completed (abandoned loads); Driver has not logged in by anticipated time; Notify Dispatch if Loads are not being fulfilled on schedule; “Grab Bag” Loads are not being serviced in a timely fashion; the middleware computer system receives completion data with selected reason code (accident, spill, etc.). It is noted that “Grab Bag” loads arise from orders which have not been assigned to a particular driver, and a driver grabs the order and processes it if the driver has the time and capability to do so. Such loads may be third party carrier initiated orders for handling by a carrier company's middleware computer system.

The middleware computer system can validate barcode fields received from downstream systems against pre-specified rules. For example, if an eight-character barcode is used to identify an order or bill of lading based on a “3 of 9” system with [0-9], [A-Z] as the range of possible character values, the 8th digit or character is a check digit to ensure accuracy at the time of data entry. Each document used or created during the fulfillment of an Assigned Delivery will be given its own barcode. The middleware computer system stores the barcode data and make it available to adapters that feed data to back office systems. A barcode labeling system can be used to handle shipper's bills of lading associated with the transportation of bulk liquid petroleum. The barcode label can be attached to the shipper's bill of lading to identify the bill of lading. An image of the bill of lading is provided to the middleware computer system along with the barcode identifier to allow for paperless handling of the bill of lading. Also other documents associated with the bill of lading can be stored in the system for retrieval.

The middleware computer system can also be configured to maintain a table of generic shift definitions. Shift information received from Order Scheduling Systems can be normalized into sequential period of day, based on number of shifts.

The middleware computer system can be configured to be the main repository of reason codes used by communication devices to identify or qualify certain events. A reason code can have a priority setting that can be used for notification settings. The middleware computer system can furnish a base set of reason codes which would be available to all carriers. Additional carrier-based reason codes can be supported and flagged accordingly. The middleware computer system can support encapsulating reason codes into ‘JAD’ files that can be installed on handheld and Cadec units. Reason codes that can be incorporated into JAD files can be flagged accordingly. A Web UI screen can provide for maintenance of reason codes.

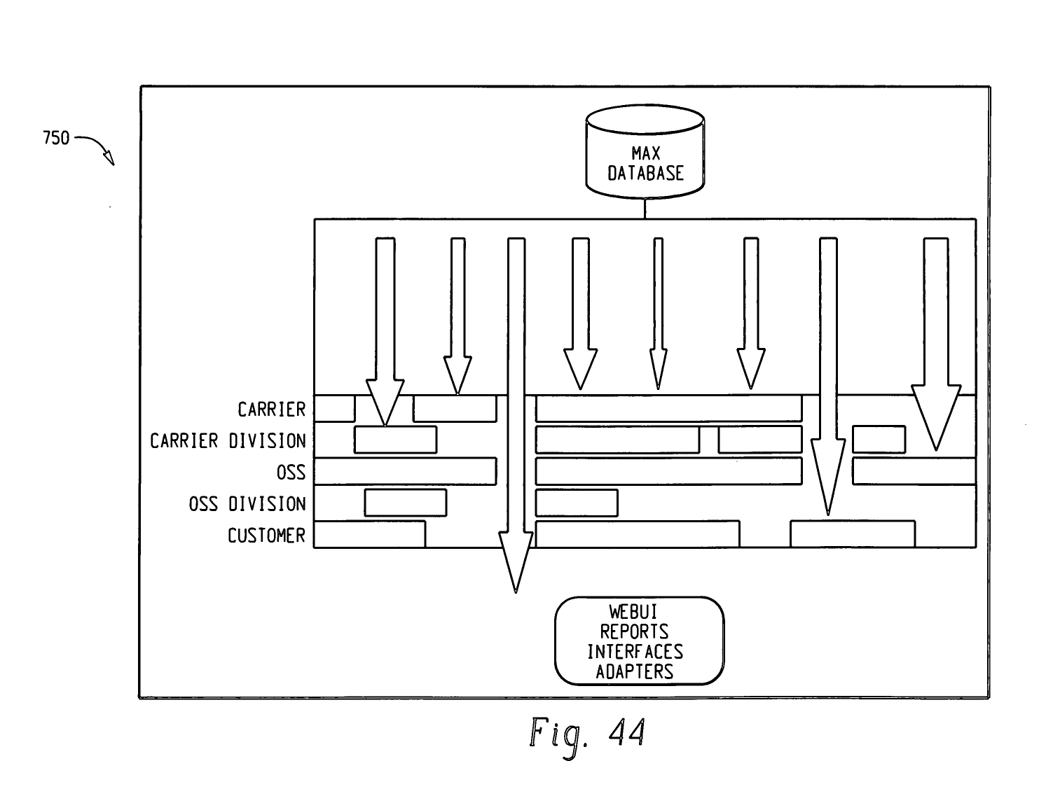

FIG. 44 depicts at 750 an approach that can be used by the middleware computer system to provide security to the information stored in the system. In the approach of FIG. 44, security is divided within its Web User Interface (Web UI) into two major sections: data filtering and functionality assignment. This allows carrier data to be separated from other third-party data. Data as it enters the system is tagged with the source of the data (e.g., did the data come from a carrier). Rules can be established with the data to determine where the data should be sent after it is processed (e.g., the data will be provided to a certain company for billing purposes). The security model allows for third-party drivers to place information into the system without a concern that an unauthorized person will access their data.

The middleware computer system's data filtering provides a mechanism with which to permit users to see only the data they are authorized to view. Each time the middleware computer system database is queried, the resulting data is passed through a filter created for a user (or user group) prior to being rendered on screen, or in report form. Filters can be customized for each user or user group and are built from combinations of Carrier, Home (Truck) Terminal, Customer Group, Customer, Order Origination System (OSS), and/or Order Origination System Division. This approach illustrates how combinations of the above items can be combined to form an effective data filter. While a large amount of data may be returned from a database query, only a small portion of the data may be able to pass through the filter and reach the user.

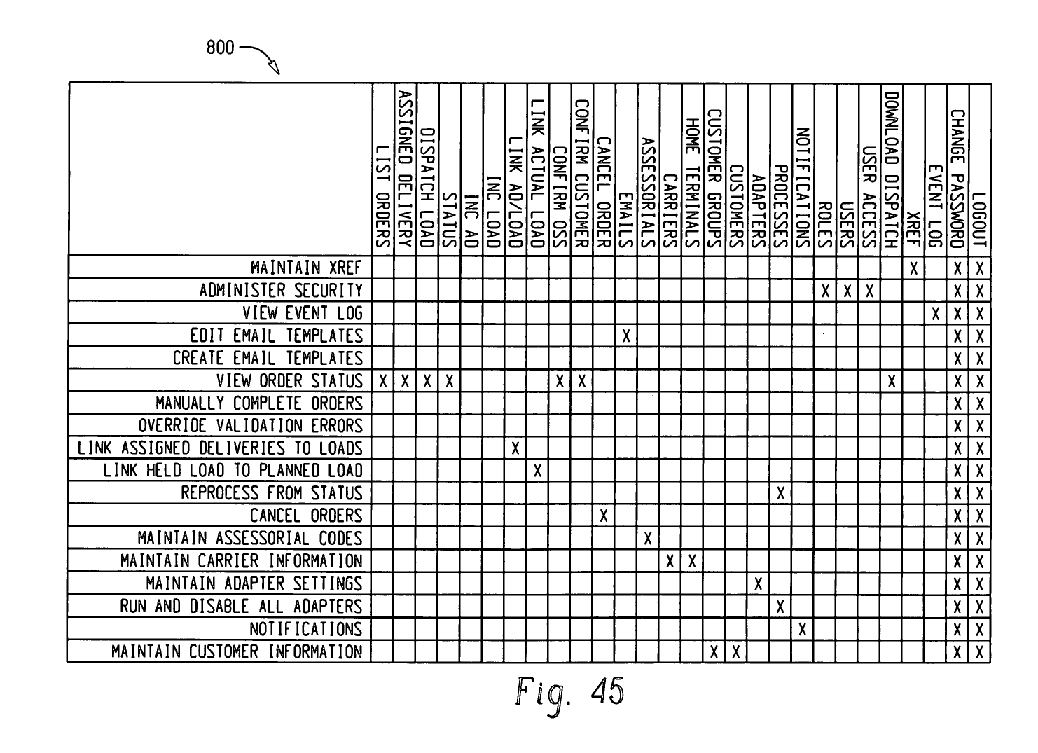

FIG. 45 illustrates at 800 a functionality security assignment example wherein the functionality assignment provides or restricts access to specific areas of the Web UI and is allocated by assigning one or more roles to users. Each role is built of one or more permissions and each user may act in more than one role. Assigning multiple roles to a user increases the number of areas in the middleware computer system to which a user has access. In the matrix of FIG. 45, the rows represent roles to which a user may be assigned, and the columns are buttons on the main control panel in the middleware computer system. Some permissions may be dependent upon others in order to be made available to a user. For instance, while it is possible to give a user permission to “Link Assigned Deliveries to Load”, the button provided to do this will not be displayed on the Web UI unless the same user has also been given the permission to “View Order Status”.

Users'0 access to any information within the middleware computer system may be restricted to any combination of the following: Specific Customer Group(s); Specific Customer(s); Specific Carrier(s); Specific Home (Truck) Terminal(s); Specific Order Scheduling System(s);

Users can be restricted, by role, for access to the following order-processing related functionality: viewing order status; manual modification of order completion; override order completion validation status; link unmatched order completion data to planned assigned deliveries; etc.

The following provides descriptions of the roles that can be used in a role-based permission scheme. A person in the role of a dispatcher performs order creation and scheduling/assignment and monitors progress of deliveries to ensure that all orders have been fulfilled. A dispatcher may act as a liaison to the Customer Processor on status of orders if necessary. A dispatch manager is a manager who supervises a group of dispatchers and may be required to authorize exceptions to/override normal business rules. A driver person is the one who actually performs the delivery of products to the Customer Station/delivery point. A carrier field manager manages a group of drivers and trucks that make deliveries. A customer is the customer listed on the customer interface on order delivery status. A system administrator performs user-security/functional authorization related to system users and. controls system operation and functional processing made available through a system user interface.

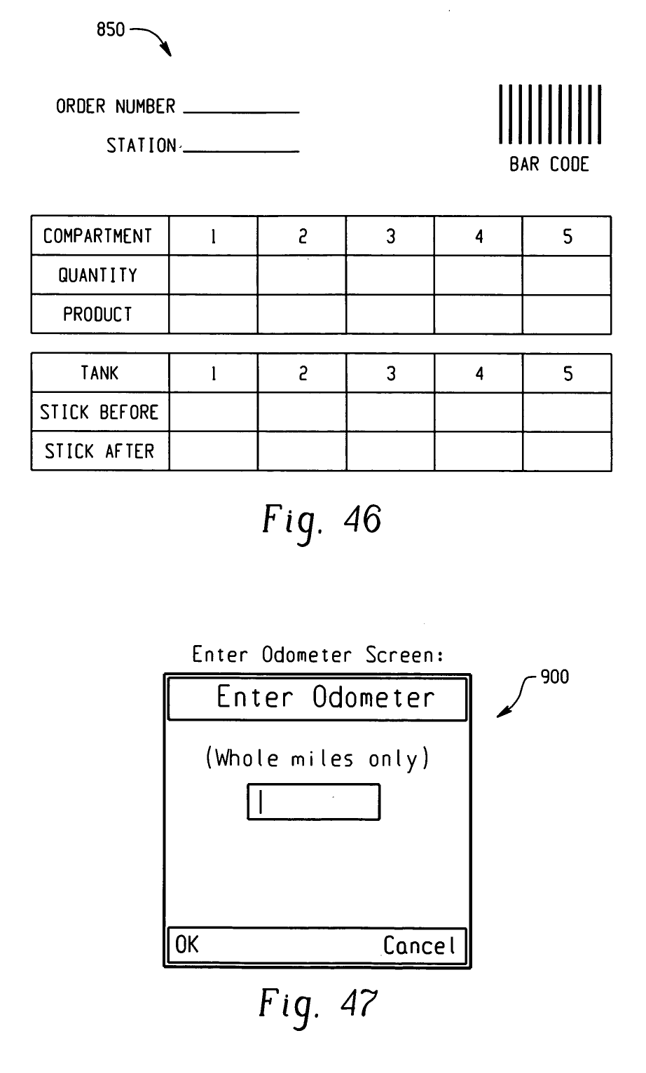

While examples have been used to disclose the invention, including the best mode, and also to enable any person skilled in the art to make and use the invention, the patentable scope of the invention is defined by claims, and may include other examples that occur to those skilled in the art. For example, the systems and methods disclosed herein may be extended to include barcode processing. As shown at 850 in FIG. 46, to help standardize the driver's process, he/she can be given a set of preprinted manual data collection stickers that are uniquely numbered and bar-coded. A sticker has a spot for the driver to manually capture the data he/she is required to collect while he/she is outside of the truck. A middleware computer system can be configured to capture the barcode data from a mobile unit and validate barcode fields using predetermined criteria. Order completion that fails barcode validation is placed in suspense. Barcodes are used to identify documents generated/collected by the driver during trip. Barcode data can be stored with delivery completion data.

FIGS. 47-92 illustrate additional examples of operational scenarios that the systems and methods disclosed herein could be configured to handle. In this operational scenario example and as shown at 900 in FIG. 47, a user interface screen displayed on a communication device prompts the driver to enter a current odometer reading of the assigned vehicle when such events as the following occurs: after initial application login, but only after order information assigned to the driver is downloaded to the mobile device; after the “Arrived” action button is pressed at a pickup or delivery stop; and/or after the “End of Shift” action button is pressed once all downloaded orders have been completed.

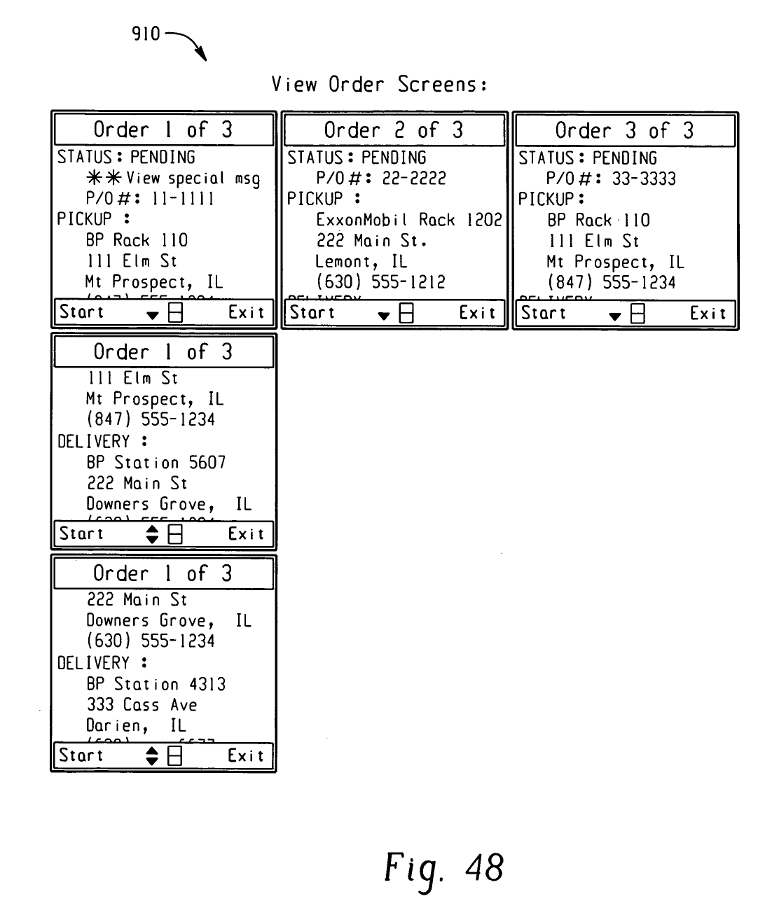

The user interface screens shown at 910 in FIG. 48 display the orders assigned to the driver that have been downloaded from the server (e.g., middleware computer system) to the mobile device. When the order information is first downloaded to the mobile device, an audible alert tone is sounded (in case the order information was not immediately available from the server). Pressing the up/down arrows on a mobile communication device allows the user to scroll through all the pickup and delivery stops of a given order (as demonstrated by the vertical set of screens shown in FIG. 48). Pressing the left/right arrows on the mobile device allows the user to scroll through the entire list of orders (as demonstrated by the horizontal set of screen shots).

In this operational scenario, a given driver's login can be one of three possible priority levels associated with it that pertain to how a driver can view order information. The lowest priority level allows the driver to view only the lowest numbered order that has a status of “Pending”. Given the screen shots in FIG. 48, a driver with the lowest priority level would not be able to use the right arrow button on the mobile device to view “Order 2 of 3” until “Order 1 of 3” is completed. A driver with the next highest level priority has the ability to view and browse all orders once they are downloaded from the server. However, this priority level only allows the driver to execute the lowest numbered order that has a status of “Pending”. All higher numbered orders that have a status of “Pending” will have no available “action” associated with the left action button.

A driver with the highest priority login can not only view and browse all the downloaded orders, the driver can also execute the orders in a sequence that the driver dictates. With this priority login, all orders with a status of “Pending” have the left action button enabled with the “Start” action. The driver has the ability to change the “purchase order number” associated an order (i.e.—“P/0#” on the screens displayed in FIG. 48) by selecting the “Change P/0#” popup menu command available on this screen (e.g., see the screen of FIG. 59 “Change Purchase Order Number”). If additional information, special instructions, etc. is available for a given order, then the text “**View special msg**” appears below the given order's status line (e.g., see the first “Order 1 of 3” screen of FIG. 48). The driver is able to view the special message text by selecting the “View Message” command off the popup menu available on this screen. The priority level associated with each driver's login can be made available via a middleware computer system database interface. When all orders have been completed, the left action button changes to “End Shift” on all orders.

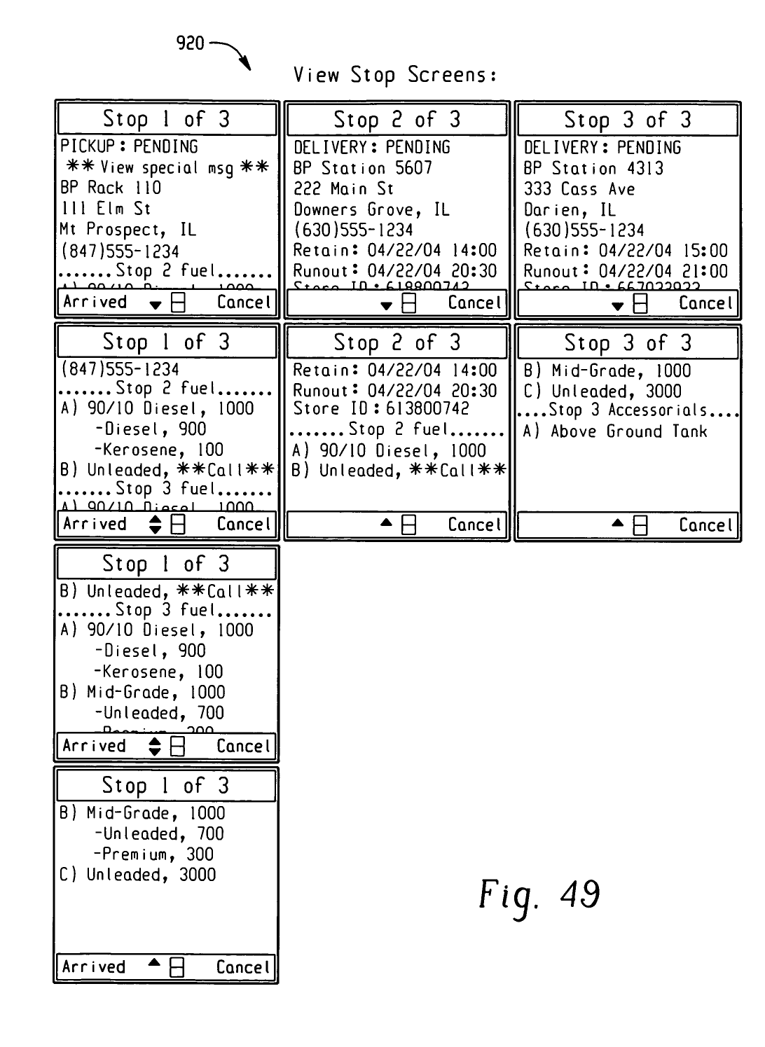

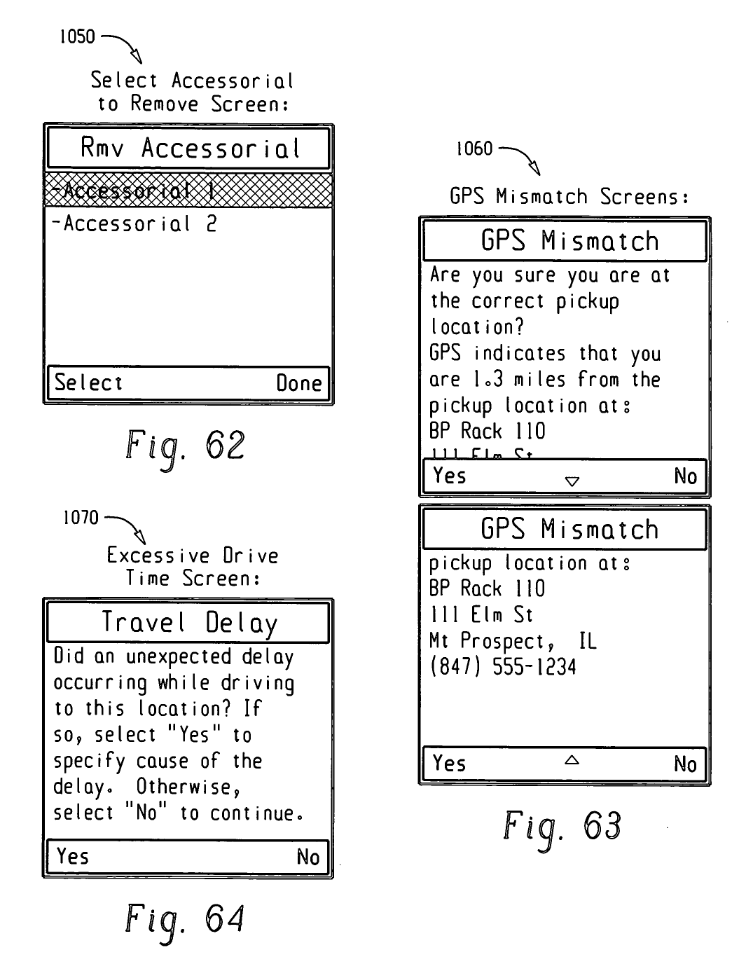

The user interface screens shown at 920 in FIG. 49 allow the driver to view and browse all the pickup and delivery stops that compose an order. However in this operational scenario example, the driver can only execute the lowest numbered stop that has a status of “Pending”. In this example, this will be the only stop that has the left action button enabled with the “Arrived” action. The driver login priorities associated with viewing/browsing/selecting orders (e.g., see the screen of FIG. 48 “View Order”) has no impact on the “View Stop” screens. A driver is always able to view and browse all stop information, but the driver can only execute the stops in ascending numerical order. Once the driver has completed all needed data entry pertaining to the activities performed at a stop, the status of the stop changes to “Completed”. The information displayed for each stop includes the name of the location, as well as its street address, city, state and phone number. Additionally, “retain” and “run out” dates and times, as well as the customer store ID, are displayed for delivery stops (but only if this information is available from the server). Information pertaining to the type(s) and amount(s) of fuel to be picked up, or to be delivered, is displayed below the location address information. The amount of fuel to load/deliver to a particular customer location may not be known at the time the order is generated. In this case, the text “**Call**” will be displayed in place of the amount of fuel to load. This is to notify the driver that the customer location needs to be contacted to determine the amount of fuel to load. An example of this shown in the screens of FIG. 49. If a known accessorial condition exists at the location, it will be displayed immediately below the detailed fuel listing (e.g., see “Stop 3 of 3” in the screens of FIG. 49). Each displayed accessorial applies to the fuel product prefaced with the same index letter (as displayed immediately above the fuel details section). Accessorial conditions may be added and/or removed by selecting the “Add Accessorial” command, or the “Remove Accessorial” command, respectively, off the popup menu available on this screen. (e.g., see the screen of FIG. 61 “Select Accessorial to Add”, and the screen of FIG. 62 “Select Accessorial to Remove”.)

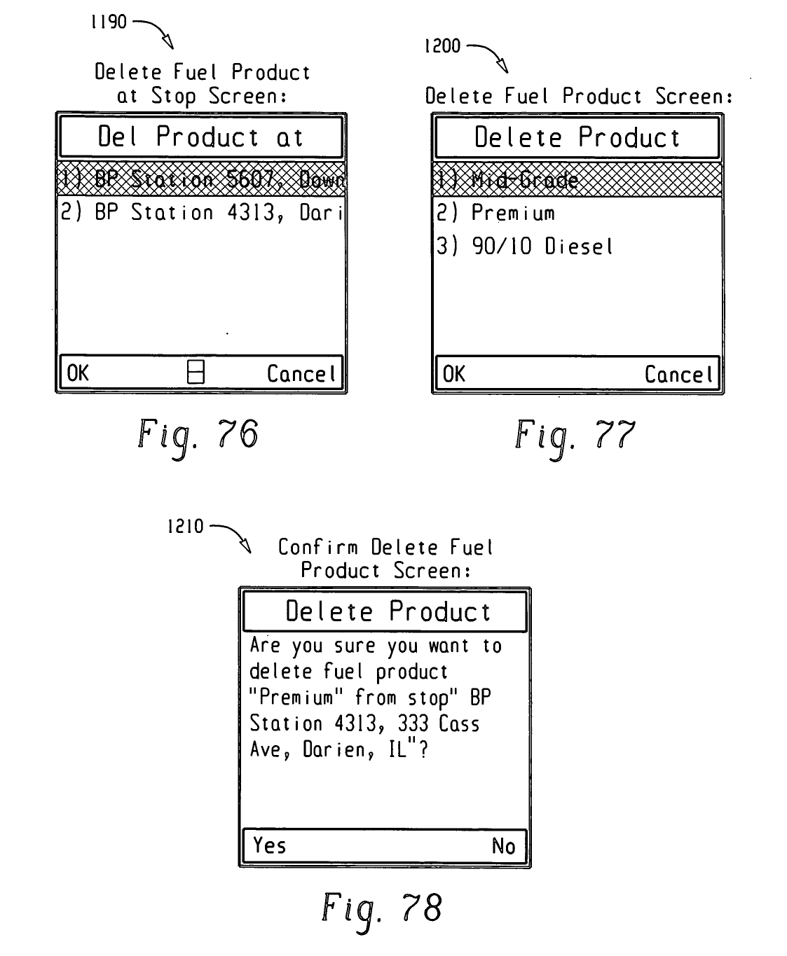

Pickup locations have more detailed fuel information when compared to the fuel information displayed for delivery locations. Pickup location fuel information is grouped first by delivery location, then by fuel product. In the case of fuel products that are “splash blended” at the loading location, the fuel product can be broken down into its individual fuel components. The gross gallons to load figure is provided for the “splash blended” fuel product, as well as for each of the individual fuel components that compose the “splash blended” fuel product. When viewing the details for a pickup location that has a status of “pending”, the driver will be able to add a fuel product to be loaded at the pickup location and delivered to a “pending” delivery location (as defined on the order currently being processed). This is accomplished by selecting the “Add Fuel Product” command from the popup menu available on this screen (which takes the user to the screen of FIG. 73 “Add Fuel Product at Stop”). The “Add Fuel Product” popup menu command can be configured to only be available when displaying stop location details for a “pickup” location that has a status of “pending”. Once a fuel product has been added, the stop details of the affected delivery location will be updated accordingly. When viewing the details for a pickup location that has a status of “pending”, the driver will be able to remove a fuel product scheduled to be delivered to a “pending” delivery location (as defined on the order currently being processed). This is accomplished by selecting the “Delete Fuel Product” command from the popup menu available on this screen (which takes the user to the screen of FIG. 76 “Delete Fuel Product at Stop”). The “Delete Fuel Product” popup menu command can be configured to only be available when displaying stop details for a pickup location that has a status of “pending”. Once a fuel product has been removed, the stop details of the affected delivery location will be updated accordingly. The mobile device's application can be configured to not allow the driver to remove a scheduled fuel product if it is the only fuel product scheduled to be delivered to the location. In this scenario (i.e., a fuel product is to be “replaced”), the new fuel product will have to be added first, followed by the existing fuel product being removed.

The date and time that the driver presses the “Arrived” action button is obtained via the mobile device's GPS interface and is reported back to the server. Once the driver selects “Arrived”, the left action button changes to “Confirm”. The “Confirm” action is selected once the driver has completed his pickup or delivery activities and is ready to record the actions performed during the pickup or delivery stop. If additional information, special instructions, etc. is available for a given stop, then the text “**View special msg**” will appear immediately below the given order's status (e.g., see the first “Stop 1 of 3” screen).The driver will be able to view the special message text by selecting the “View Message” command off the popup menu available on this screen The date and time that the driver presses the “Arrived” action button is obtained via the mobile device's GPS interface and is reported back to the server.

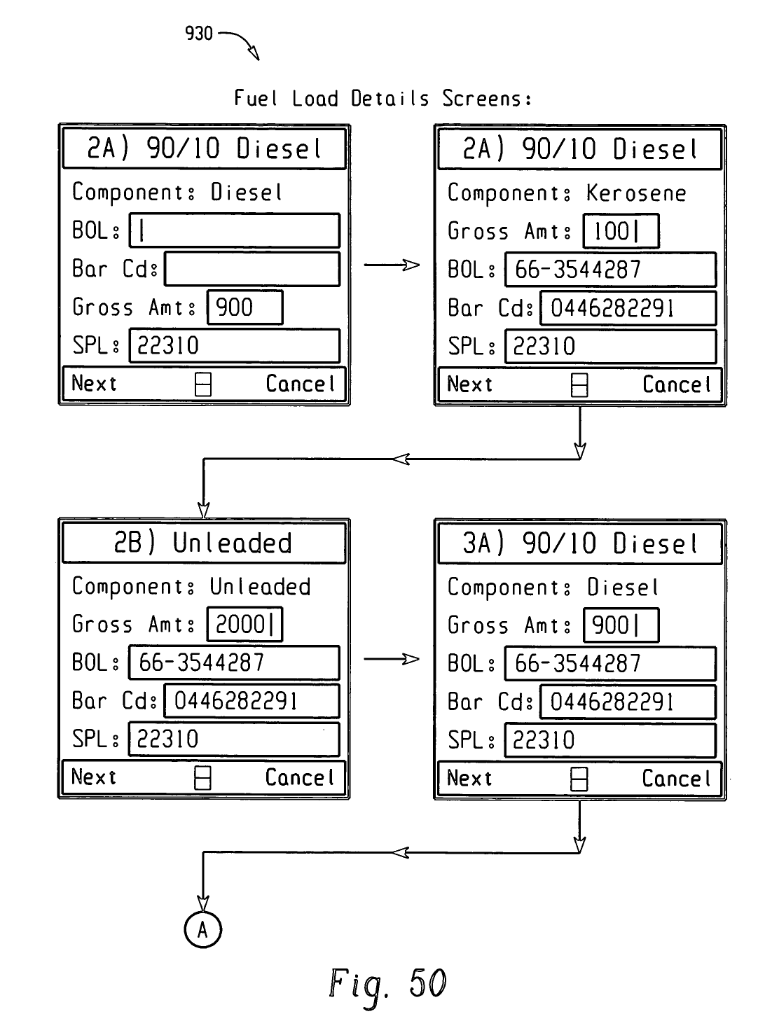

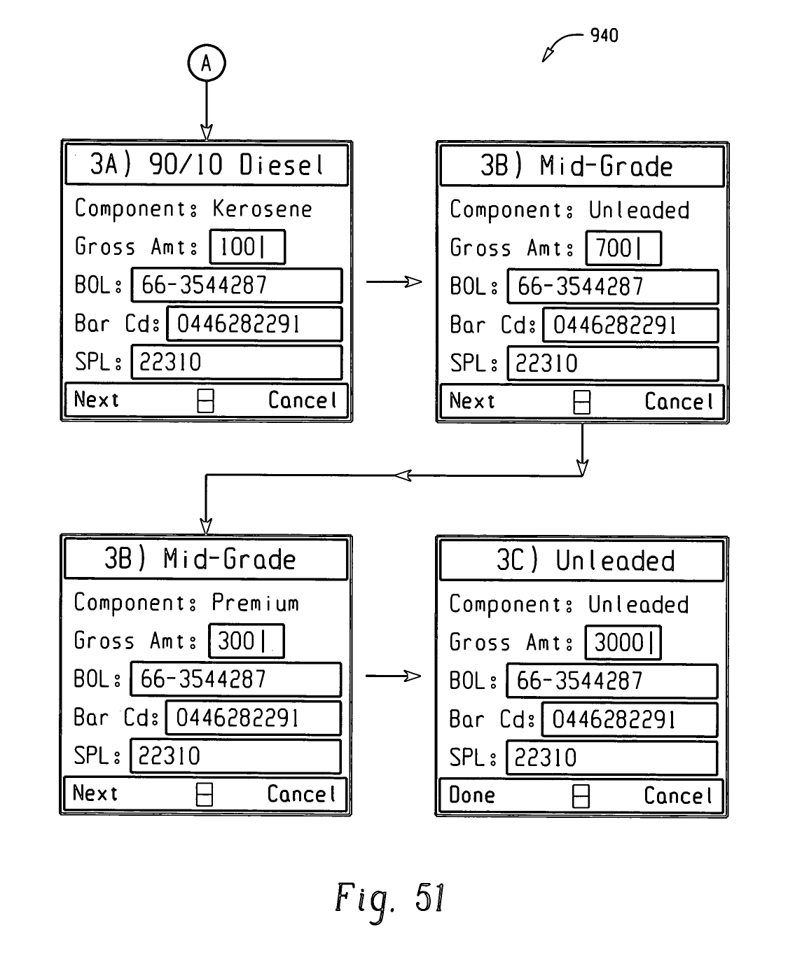

FIGS. 50 and 51 show respectively at 930 and 940 a series of screens shots which provide an example of a sequence of “Fuel Load Detail” screens that would be seen by the driver based on order data for “Stop 1 of 3” as discussed above. Navigation to the next screen occurs by selecting the “Next” action button. The “Done” action is displayed on the last screen to signify the end of the “Fuel Load Detail” sequence. The initial Fuel Load Detail screen shown in FIG. 50 is displayed when the driver selects the “Confirm” action button on a “View Stop” screen. A “Fuel Load Detail” screen is displayed for each fuel product to be delivered. If a given fuel product is to be delivered to more than one delivery location, a “Fuel Load Detail” screen is displayed for each delivery location that is scheduled to receive that fuel product. Each fuel product scheduled to be loaded is displayed in the title bar area. The fuel product is prefaced with its associated delivery stop number, followed by an “A”-originated letter. This letter can be used to order the fuel products when multiple fuel products are to be delivered to a given location. If a given fuel product is to be splash blended at load time, then a “Fuel Load Detail” screen is displayed for each of the fuel “components” that compose the splash blended fuel product.

The screens allow for the entry of the “Bill Of Lading Number” (BOL#), and the corresponding “Carrier specific Tracking Number” (Bar Cd#). Once the BOL# and Bar Cd# values have been entered, the values are carried forward to each subsequent “Fuel Load Detail” screen. The driver can enter a secondary “Bill Of Lading Number” and/or “Carrier-specific Tracking Number” at any time by simply backspacing over the pre-filled contents of the “BOL#” field and/or “Bar Cd#” field and typing in the new information. The source of the “Carrier-specific Tracking Number” can be a sheet of pre-printed decal provided to the driver by dispatch. The tracking number can be in the form of a bar code on each decal, but can also be displayed numerically below the bar code. If the mobile device being used by the driver is equipped with a bar code scanning device, then the driver can use this device to scan in the bar code from the decal directly into the “Bar Cd#” field on the mobile device display. The decal can then be placed onto the “Bill of Lading” form. This screen also allows the driver to enter the gross gallons loaded for a given combination of fuel product and delivery stop. The “Gross Amt” field is pre-filled with the amount of fuel designated to be loaded from the original order data. If the fuel product shown in the title bar is a type of fuel created via a splash blend at load time, then multiple “Fuel Load Detail” screens are displayed—one for each fuel component that is blended together. The fuel component whose gross gallons are to be entered is displayed mid-screen, prefaced with the prompt text “Component:”. The fuel “supplier” number (supplied in the order information obtained from a middleware computer system database interface) can be pre-filled in the “SPL#” field. If the supplier number obtained from a middleware computer system database is incorrect, or if the fuel supplier must be changed due to unforeseen circumstances at the loading facility, the driver can simply delete the existing, pre-filled supplier number and enter the replacement supplier number.

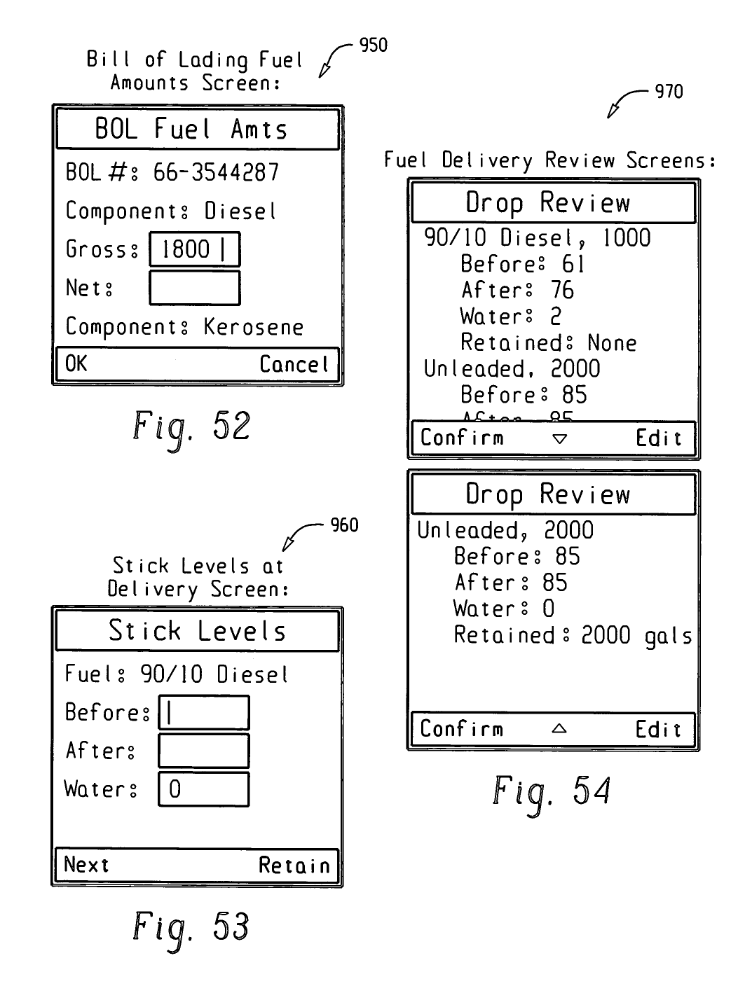

The user interface screen shown at 950 in FIG. 52 allows the driver to enter the gross gallons loaded, and the net gallons loaded, for the specified fuel component from the figures presented on the “Bill of Lading” (BOL) with the specified BOL number. All fuel components that share the same BOL number (as entered on the screens of FIGS. 50 and 51 “Fuel Load Details”) can have “Gross” and “Net” entry fields on this screen. The “Gross” entry fields will be pre-filled with the anticipated gross volume loaded based on the figures as entered on the screens of FIGS. 50 and 51 “Fuel Load Details”. If the driver was issued multiple bills of lading at a given rack, then a screen of this type will be presented to the driver for each unique BOL entered previously on the screens of FIGS. 50 and 51 “Fuel Load Details”. In this case, the left action button will read “Next” until the screen for the last unique BOL number is reached, at which time the left action button will change to read “Ok”.

The user interface screen shown at 960 in FIG. 53 allows the driver to enter the stick before reading, the stick after reading, and the water before reading for the delivery of a specific fuel product. The water before field will be pre-filled with a value of zero (0) inches. If the driver was unable to perform a full drop (wherein a full drop includes all or substantially all of the fuel is delivered for a particular delivery), then it can be configured such that the driver must select the “Retain” action. This will allow the driver to specify the amount of fuel that has been retained in the trailer (e.g., see the screen of FIG. 91 “Fuel Retain Amount”). This screen can be presented to the driver for each fuel product scheduled for delivery at the current stop. If the stick levels for another fuel type are yet to be entered, then the left action button will read “Next”; otherwise, left action button will read “Done”.

The user interface screen shown at 970 in FIG. 54 allows the driver to review all of the fuel drops (e.g., delivery) data entered for the stop being executed. Selecting the “Edit” action allows the driver to edit the stick level reading previously entered. This can be accomplished by taking the driver through the “Stick Levels at Delivery” screen sequence (e.g., see the screen of FIG. 53 “Stick Levels at Delivery”), but with all entry fields pre-filled with the data previously entered by the driver. Any changes made by the driver during the “edit mode” review replaces the data originally entered by the driver.

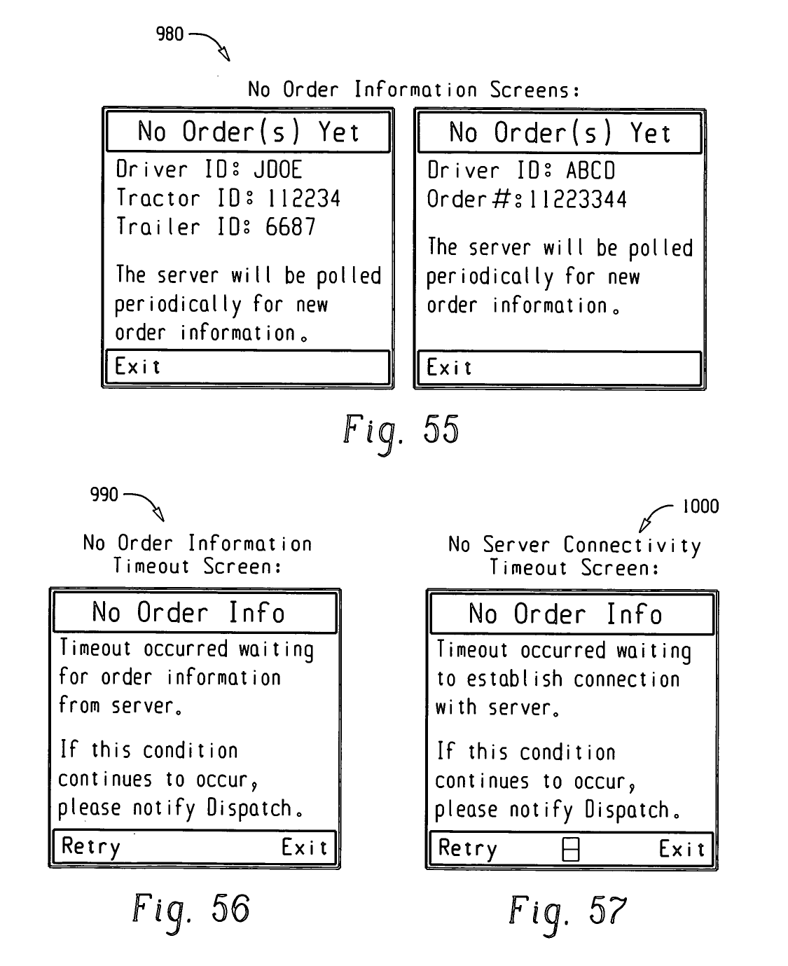

The user interface screen shown at 980 in FIG. 55 is displayed when the initial driver login information has been communicated to the server, and the server has determined that no order information is yet available from a middleware computer system interface based on the login information provided. If the user is a carrier-employed driver, then the screen on the left-side is displayed. If the user is a contracted driver, the screen on the right-side is displayed. The mobile application will periodically poll the server for new trip information when this screen is displayed, for a pre-specified amount of time. If this period of time elapses without order information becoming available, then the user interface screen shown at 990 in FIG. 56 “No Order Information Timeout” is displayed. An audible alert is generated when this condition occurs. The driver can attempt to connect to the remote server again by selecting the “Retry” action button, or exit the mobile application by selecting the “Exit” action button.

The user interface screen shown at 1000 in FIG. 57 is displayed when the mobile application cannot establish connectivity with the server within a pre-specified amount of time after application login. An audible alert is generated by the mobile application when this condition occurs. The driver can attempt to connect to the remote server again by selecting the “Retry” action button, or exit the mobile application by selecting the “Exit” action button.

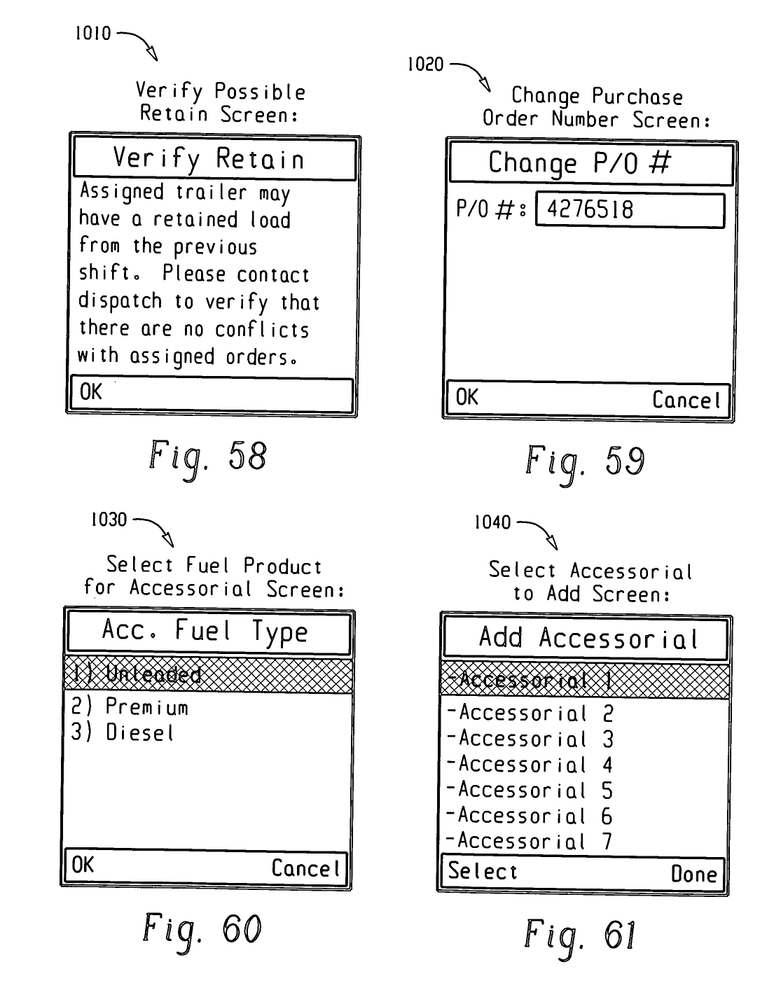

The user interface screen shown at 1010 in FIG. 58 is displayed after driver login if it is determined that the trailer assigned to the driver may have a retain condition present from a previous shift. The application requests that the driver confirm the existence of the retain condition with dispatch to ensure that there are no conflicts with the currently assigned orders.

The user interface screen shown at 1020 in FIG. 59 allows the user to change the purchase number order associated with the current order. The screen is displayed when the driver selects a “Change P/O#” menu selection available on the screen of FIG. 48 “View Order”.

The user interface screen shown at 1030 in FIG. 60 prompts the driver to select the fuel product for which to display the list of known accessorial conditions. The screen is displayed when the driver selects the “Add Accessorial” or “Remove Accessorial” menu selection available on the screens of FIG. 49 “View Stop”. The screen of FIG. 60 can be configured to only be displayed when the current stop has more than one fuel product scheduled to be picked up or delivered. Otherwise, either the screen of FIG. 61 “Select Accessorial to Add” or the screen of FIG. 62 “Select Accessorial to Remove” will be immediately after the “Add Accessorial” or “Remove Accessorial” menu item is selected, respectively.

The user interface screen shown at 1040 in FIG. 61 allows the user to define one or more accessorial conditions that exist for the previously selected fuel product (e.g., see the screen of FIG. 60 “Select Fuel Product for Accessorial”) at the current stop. Any accessorial conditions that were already defined for the previously selected fuel type at the current stop will not be present in the displayed list.

The user interface screen shown at 1050 in FIG. 62 allows the user to remove one or more accessorial conditions that are currently associated with the previously selected fuel product (e.g., see the screen of FIG. 60 “Select Fuel Product for Accessorial”) at the current stop.

The user interface screens shown at 1060 in FIG. 63 are displayed when the GPS reading taken when the “Arrived” action button is pressed does not match the corresponding GPS data received from a middleware computer system database interface for the same location (within a specified delta). If the “Yes” action button is pressed, the GPS reading taken by the mobile application is sent back to a middleware computer system database interface.

The user interface screen shown at 1070 in FIG. 64 is displayed when the amount of travel time to a delivery stop, as calculated by the mobile application, exceeds a system defined amount of time.

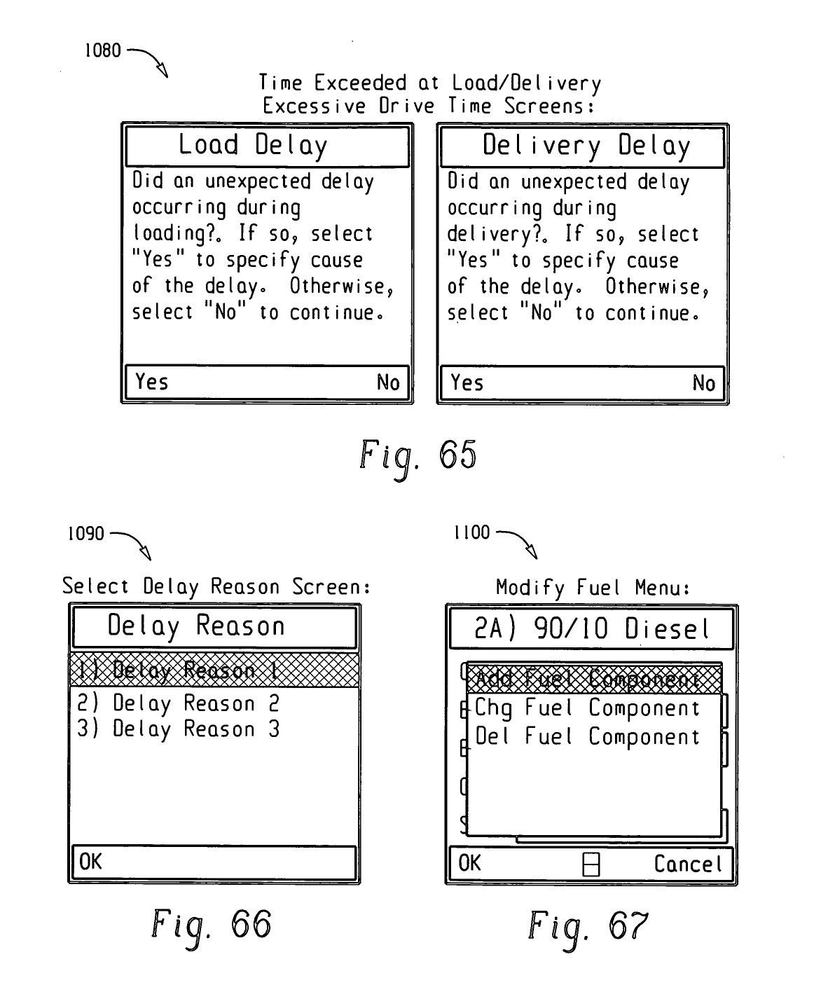

The user interface screens shown at 1080 in FIG. 65 are displayed when the amount of time between the “Arrived” and “Confirm” action button presses exceeds a system defined amount of time at a stop. Two “time exceeded” application parameters can be defined—one for rack loading time, and one for delivery drop time.

The user interface screen shown at 1090 in FIG. 66 allows the driver to specify a cause for the excess loading or delivery time incurred at a location, or for the excess time taken to arrive at a pickup or delivery location.

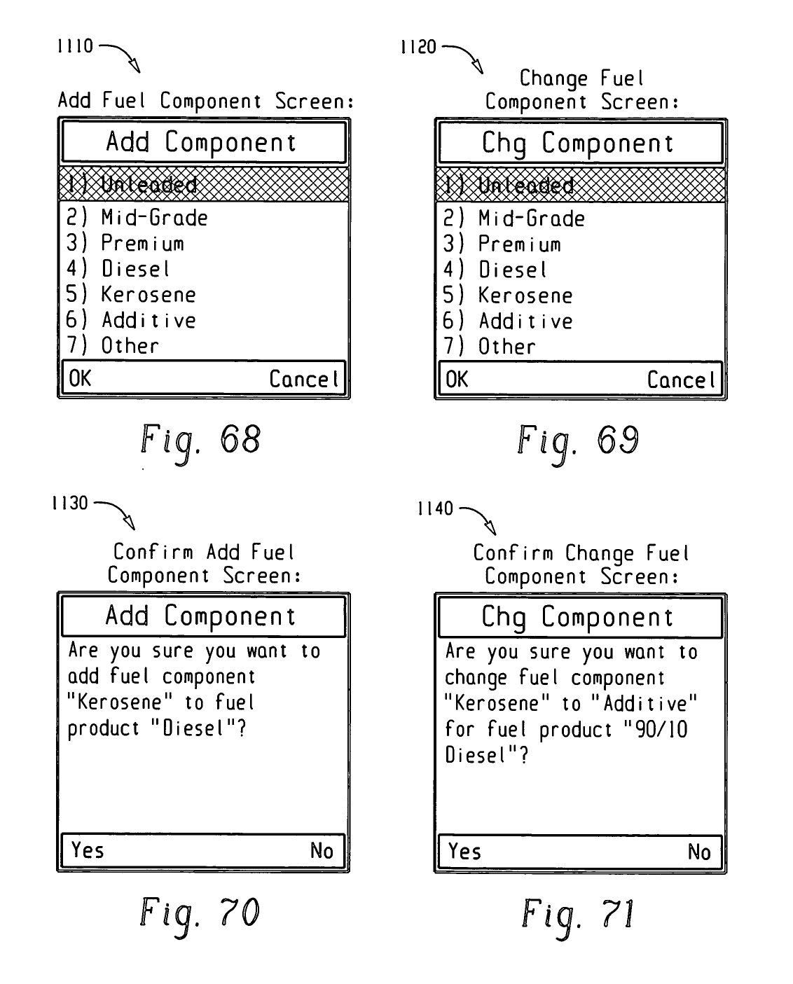

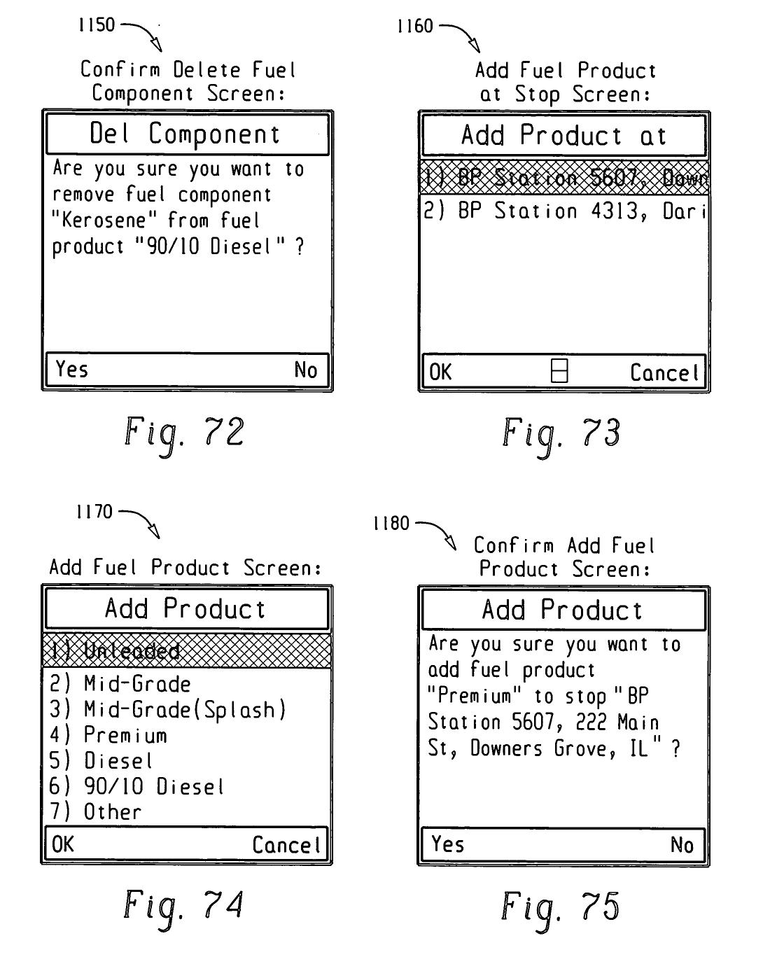

The user interface screen shown at 1100 in FIG. 67 shows an example of a menu displayed when the “menu” button is pressed on a “Fuel Load Details” screen (e.g., see the screens of FIGS. 50 and 51 “Fuel Load Details”). The driver can add a fuel component (e.g., see the screen of FIG. 68 “Add Fuel Component”), change a fuel component (e.g., see the screen of FIG. 69 “Change Fuel Component”), or delete a fuel component (e.g., see the screen of FIG. 72 “Confirm Delete Fuel Component”) pertaining to a fuel product to be delivered to a customer location on the current order on by selecting the appropriate menu entry. The mobile application can be configured not to allow the driver to remove a fuel component from a fuel product that has only one component defined (in which case the “Delete Fuel Component” menu item will not be available). In this situation of the operational scenario example, a new fuel component should first be added, after which time the existing fuel component can then be removed.

The user interface screen shown at 1110 in FIG. 68 allows the driver to add a fuel component to a given type of fuel that was not specified in the original order data. The items displayed can be obtained from a “canned”/pre-determined set of default fuel components. When the “Ok” action is selected, the selected fuel component can be immediately inserted into a “Fuel Load Detail” screen sequence (e.g., see the screens of FIG. 50 and 51 “Fuel Load Details”). The fuel component that was displayed when the menu was invoked to add a fuel component will be displayed next in the sequence of fuel components.

The user interface screen shown at 1120 in FIG. 69 allows the driver to change a fuel component of a given fuel product. The items displayed can be obtained from a “canned” set of default fuel components.

The user interface screen shown at 1130 in FIG. 70 is a confirmation screen that is displayed after the driver has specified that a new fuel component is to be added to the fuel product currently being processed.

The user interface screen shown at 1140 in FIG. 71 is a confirmation screen that is displayed after the driver has specified that the current fuel component being processed is to be changed to a different type of fuel component.

The user interface screen shown at 1150 in FIG. 72 is a confirmation screen that is displayed after the driver has specified than an existing fuel component is to be removed from a fuel product currently being processed. The mobile application can be configured so as not to allow the driver to remove a fuel component from a fuel product that has only one component defined.

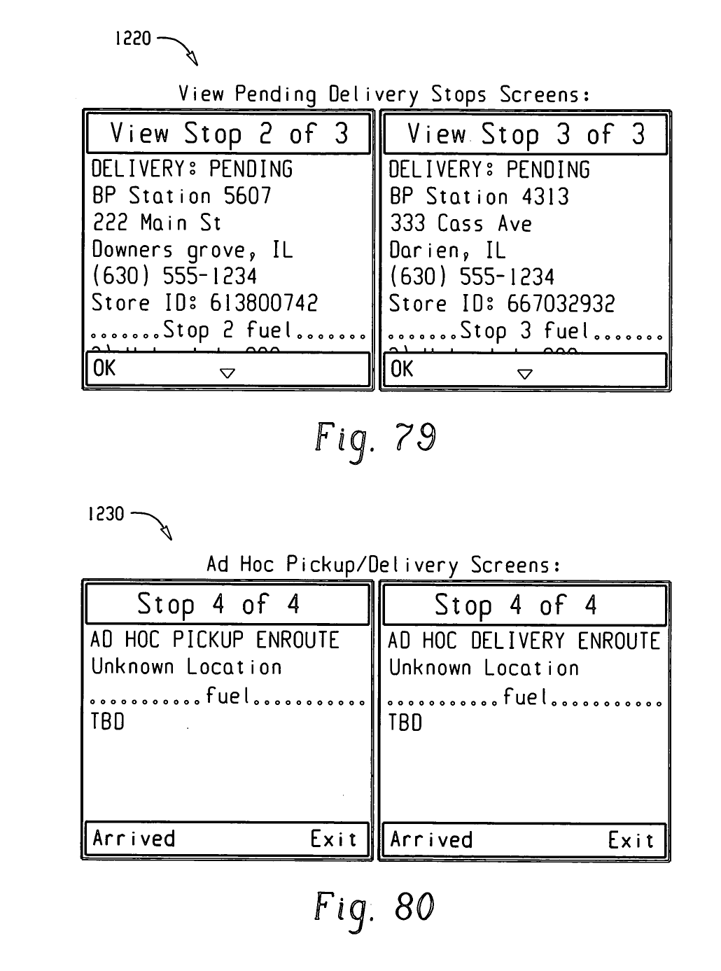

The user interface screen shown at 1160 in FIG. 73 is displayed when the driver selects “Add Fuel Product” from a popup menu available on the screens of FIG. 49 “View Stop”. The application can be configured so that only pickup stops with a status of “Pending” will have the “Add Fuel Product” command available on the popup menu. The user will not be able to add fuel products on “View Stop” screens that are displaying delivery location information. The screen prompts the driver to select the scheduled delivery stop to which the new fuel product is to be added on the order currently being processed. Only delivery stops that have a status of “Pending” are displayed in the selection list. A popup menu can be provided on this screen (e.g., “View Pending Stops”) to allow the driver to review all delivery stops on the current order that have a status of “Pending” (e.g., see the screen of FIG. 79 “View Pending Delivery Stops”).

The user interface screen shown at 1170 in FIG. 74 is displayed after the driver selects a pending delivery stop to add a fuel product to (e.g., see the screen of FIG. 73 “Add Fuel Product at Stop”). The screen allows the driver to specify the fuel product to add to the pending delivery stop on the order current being processed.

The user interface screen shown at 1180 in FIG. 75 is a confirmation screen that is displayed after the driver has specified that a new fuel product is to be added to a pending delivery location on the order currently being processed.

The user interface screen shown at 1190 in FIG. 76 is displayed when the driver selects “Delete Fuel Product” from the popup menu available on the screens of FIG. 49 “View Stop”. The application can be configured such that only pickup stops with a status of “Pending” will have the “Delete Fuel Product” command available on the popup menu. The user will not be able to delete fuel products on “View Stop” screens that display delivery location information. The screen prompts the driver to select the scheduled delivery stop from which a fuel product is to be removed on the order currently being processed. Only delivery stops that have a status of “Pending” are displayed in the selection list. Only delivery stops that have multiple products scheduled to be delivered will appear in this screen's selection list.

The application can be configured so as to not allow the driver to remove a scheduled fuel product if it is the only fuel product scheduled to be delivered to the location. In this scenario (i.e., a fuel product is to be “replaced”), the new fuel product is to be added first, followed by the existing fuel product being removed. A popup menu can be provided on this screen (e.g., “View Pending Stops”) to allow the driver to review all delivery stops on the current order that have a status of “Pending” (e.g., see the screen of FIG. 73 “View Pending Delivery Stops”).

The user interface screen shown at 1200 in FIG. 77 is displayed after the driver selects a pending delivery stop for the purpose of removing a fuel product that is scheduled to be delivered (e.g., see the screen of FIG. 76 “Delete Fuel Product at Stop”). The screen allows the driver to select the scheduled fuel product to be removed from the pending delivery stop on the order current being processed.

The user interface screen shown at 1210 in FIG. 78 is a confirmation screen that is displayed after the driver has specified that a scheduled fuel product is to be removed from a pending delivery location on the order currently being processed.

The user interface screens shown at 1220 in FIG. 79 are displayed when the user selects the “View Pending Stops” item on the popup menu available on the screen of FIG. 73 “Add Fuel Product at Stop”, or on the screen of FIG. 76 “Delete Fuel Product at Stop”. The screen displays stop information for all delivery stops on the current order that have a status of “Pending”. The information displayed for a given stop, as well as the means to navigate from stop to stop may be the same as described for the screens of FIG. 49 “View Stop”.

The user interface screens shown at 1230 in FIG. 80 are invoked by selecting the “Ad Hoc Pickup” or “Ad Hoc Delivery” commands from the popup menu available on the screen of FIG. 49 “View Stop” (e.g., “ad hoc” being unplanned or impromptu). This feature can be utilized to properly record a pickup or a delivery stop that was not part of the original data set received from the server. GPS location data for the ad hoc location is recorded and sent to server when the “Arrived” action button is pressed.

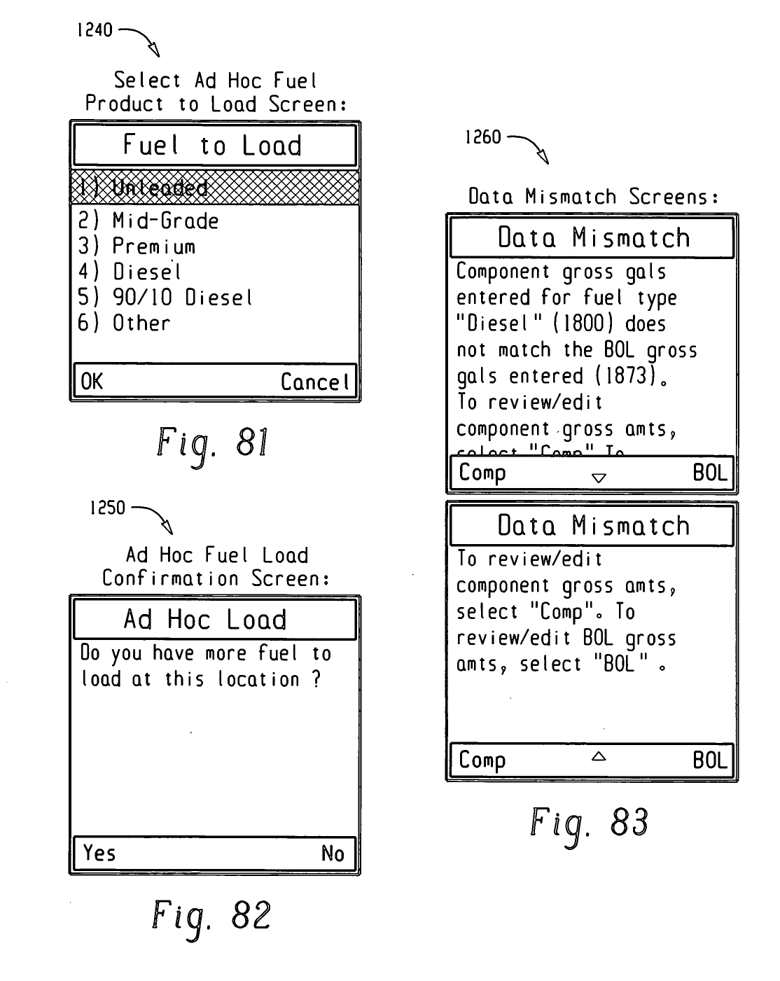

The user interface screen shown at 1240 in FIG. 81 is displayed during the processing of an ad hoc pickup. Since there is no specific order data on which to base the ad hoc load sequence, the application prompts the driver to specify the fuel product that was loaded. The fuel products displayed can be obtained form a “canned” list of fuel products (and associated codes) as determined by the carrier.

The user interface screen shown at 1250 in FIG. 82 is utilized during the processing of an ad hoc pickup. Since there is no specific order data on which to base the ad hoc load sequence in this operational scenario, the application asks the driver if another fuel product is to be loaded.

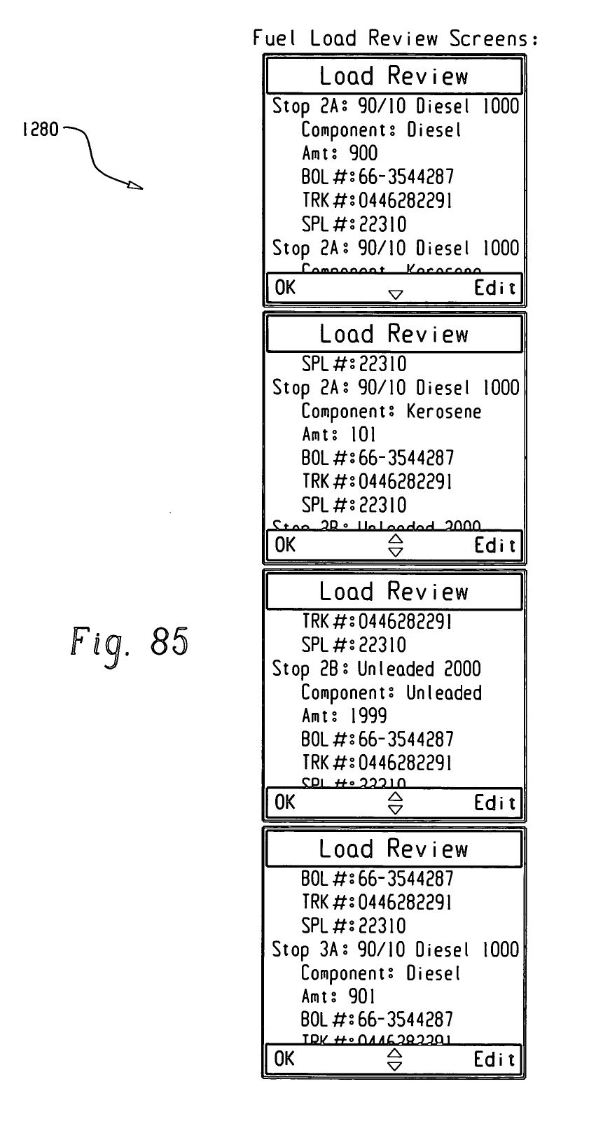

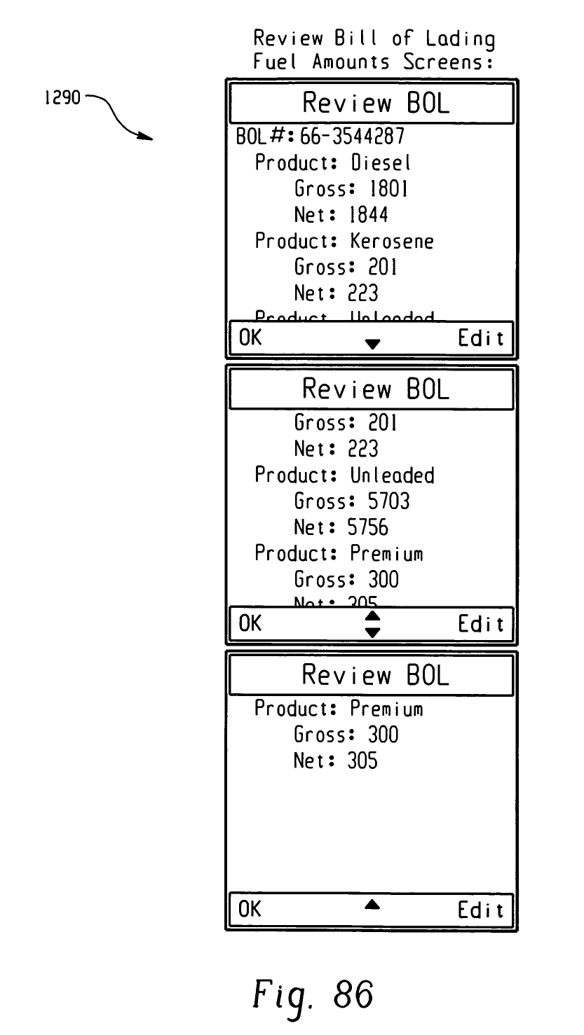

The user interface screens shown at 1260 in FIG. 83 are displayed when the sum of the gross gallons entered by the driver for a given fuel product does not match the gross gallon figure specified on the bill of lading (also entered previously by the driver). The application can be configured to require that these figures match. The driver will be able to review, and edit if necessary, the gross gallons entered on a per-fuel component/per-delivery-location basis by selecting the “Component” action button (e.g., see the screen of FIG. 85 “Fuel Load Review”). The driver will be able to review, and edit if necessary, the gross gallons entered from the bill of lading on a per-fuel-type basis by selecting the “BOL” action button (e.g., see the screen of FIG. 86 “Review Bill of Lading Fuel Amounts”).

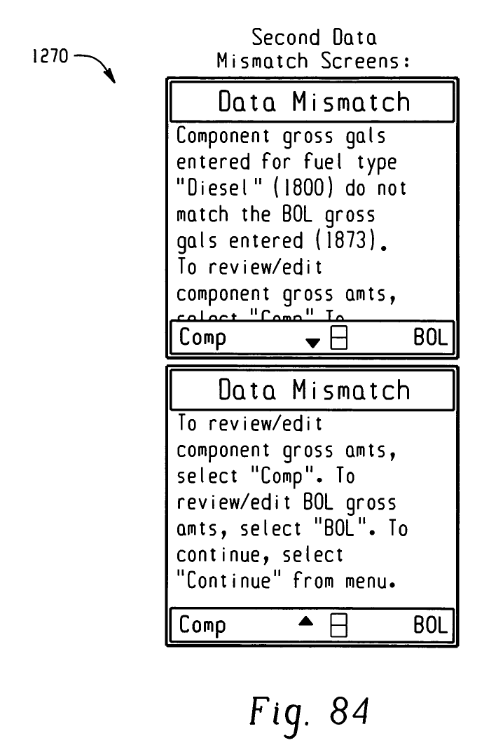

The user interface screens shown at 1270 in FIG. 84 can have the same functionality as described for the screens of FIG. 63, but can also have the additional feature of a “Continue” action command (available via the menu). Selecting the “Continue” command will suppress any further validation of the sum of the gross gallons entered by the driver for a given fuel type and the corresponding figure entered from the bill of lading.

The user interface screens shown at 1280 in FIG. 85 allow the driver to review all “Fuel Load Detail” data entered before committing the data to the server. Selecting the “Edit” action button allows the driver to revise any data entered. This is accomplished by taking the driver through the “Fuel Load Detail” data entry sequence again (e.g., see the screens of FIGS. 50 and 51 “Fuel Load Details”), but with all entry fields pre-filled with the data previously entered by the driver. Any changes made by the driver during this “edit mode” review replaces the data originally entered by the driver.

The user interface screens shown at 1290 in FIG. 86 allow the driver to review all the data entered using the screen of FIG. 52 “Bill of Lading Fuel Amounts”. Selecting the “Edit” action button will allow the driver to revise any data that was entered incorrectly using the screen of FIG. 52 “Bill of Lading Fuel Amounts”.

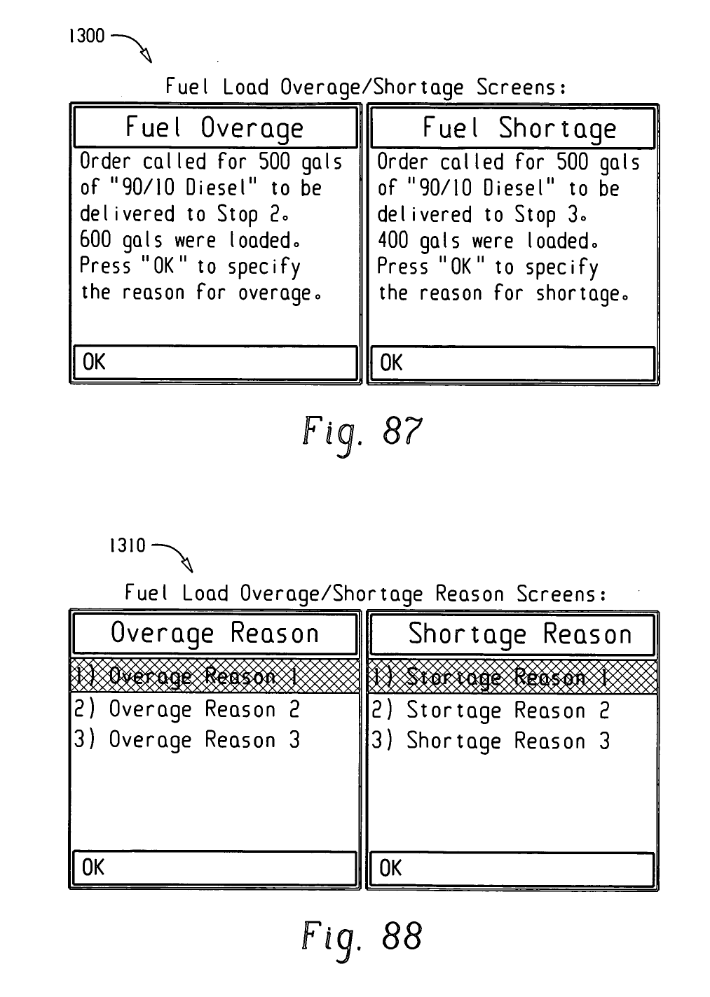

The user interface screens shown at 1300 in FIG. 87 are displayed during a pickup when the amount of fuel loaded for a given type exceeds the amount specified by the order (an “overage”), or is below the order amount (a “shortage”). The amount of “overage/shortage” (in gallons) that triggers these screens to be displayed can be specified by a pre-defined application parameter.

The user interface screens shown at 1310 in FIG. 88 allow the driver to specify a reason for why a load shortage or load overage was incurred.

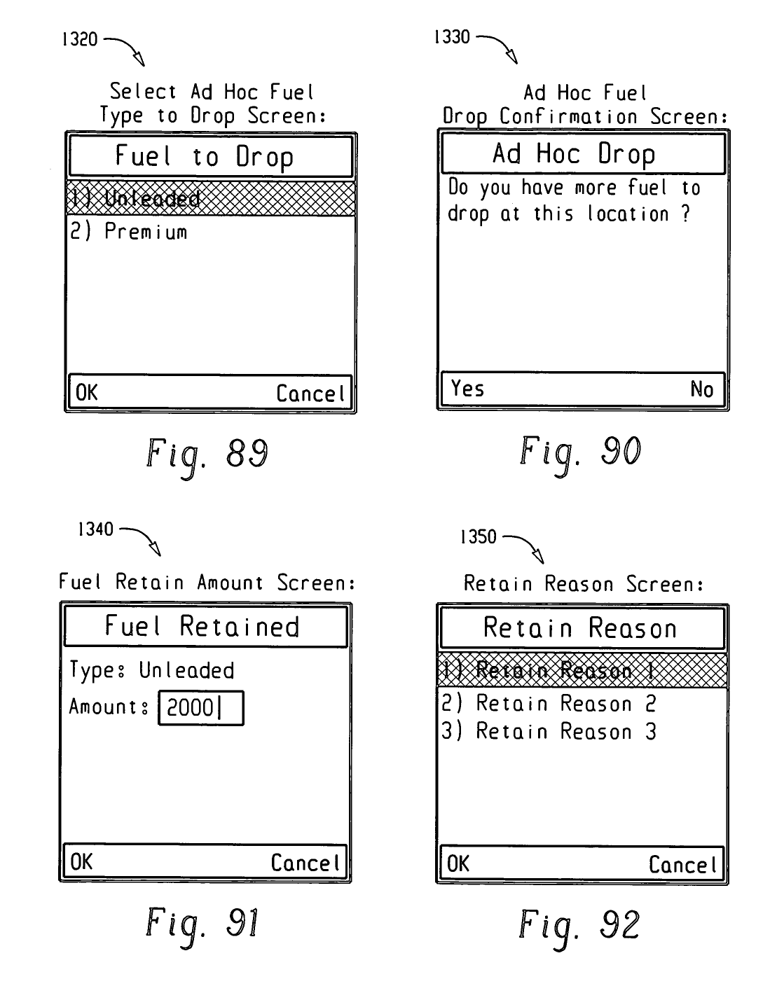

The user interface screen shown at 1320 in FIG. 89 can be utilized during the processing of an ad hoc delivery. Since there is no specific order data on which to base the drop sequence in this operational scenario, the application prompts the driver to specify the fuel type that was dropped. The list is populated only with fuel types that are currently loaded on the trailer.

The user interface screen shown at 1330 in FIG. 90 can be utilized during the processing of an ad hoc delivery. This screen is displayed after the data for an ad hoc drop has been recorded and there is still fuel remaining in trailer. Since there is no specific order data on which to base the drop sequence, the application asks the driver if another fuel type is to be dropped.

The user interface screen shown at 1340 in FIG. 91 allows the driver to specify the amount of fuel retained during a drop. The field is pre-filled with the gross amount loaded of the fuel type retained. However, the driver can modify this default value in the event that a partial drop, or a “broken compartment”, has occurred.

The user interface screen shown at 1350 in FIG. 92 allows the driver to specify the reason why a retain event has taken place.

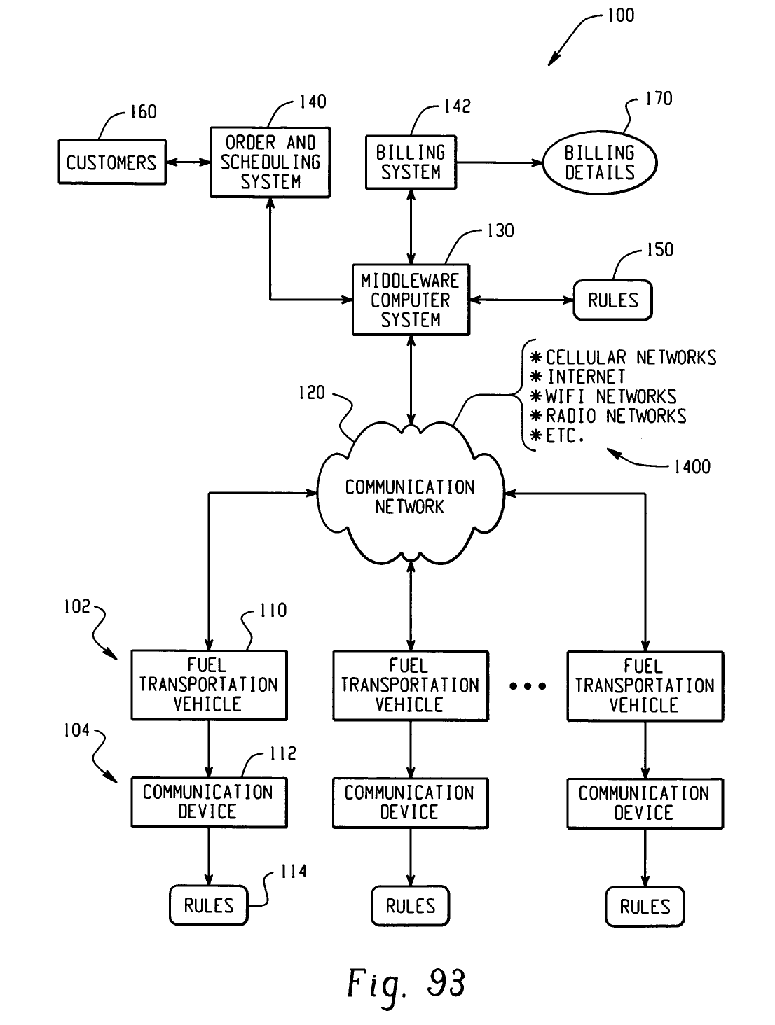

As another example of the wide scope of the systems and methods described herein, a system and method can be configured to use one or more communication networks. As shown in FIG. 93 at 1400, a communication network can include a cellular communications network, an Internet communications network, a wireless communications network, a radio communications network, etc. A fuel transportation vehicle/operator can have their communication device configured to communicate via one or more of the different types of communications network, or multiple communication devices can be used by a vehicle/operator to communicate over the different types of communication networks.

As an illustration, a driver can download their load information and send/receive other information while at the driver's station via the WIFI communications network that is available at the driver's station. The driver can use the high bandwidth capability of WIFI while in range of the WIFI communications network to communicate with a remote server (e.g., a middleware computer system). When the driver leaves the WIFI coverage, another type of communications network (e.g., cellular network, satellite, etc.) can be used to communicate with the remote server (e.g., a middleware computer system).

A vehicle/operator can have a first communication device that has WIFI communications capability as well as use other devices (e.g., a cell phone) to communicate with the remote server. A vehicle could have the same communication device communicate over different communication network types. As an illustration, a CADEC unit can communicate over a radio-based communications network and also be configured to communicate over a WIFI-based network. A CADEC unit can be configured to have WIFI capability, such as by fitting one of its expansion slots with a Sierra Air Card.

The large bandwidth/high speed capability of WIFI can be used to transmit in the morning the bulk of the data from the server that the driver needs to fulfill orders, and the other communication networks can be used outside of the WIFI range to transmit data to the driver throughout the day. The data transmitted after the initial download may be less since it may only constitute the changes to the driver's fuel orders.

The WIFI communications capability can also be used at locations other than the driver's initial location, such as at filling stations or drop off locations that have WIFI communications capability.

As another example of the wide scope of the systems and methods disclosed herein, a middleware computer system can use the PCATS standard to accommodate import of all Assigned Delivery and supporting (Carrier, Customer, Station, Terminal, Supplier, Product, etc.) data from XML files without reliance on a direct interface into the order scheduling system. A transmitting customer can supply all supporting data, and no additional lookup tables (or at least a minimal number of lookup tables) or cross-reference tables will be used within the middleware computer system to facilitate this process. XML files can be created using the PCATS standard containing delivery completion data that will be sent to the order originating customer.

As another example, when order information is sent to a communication device, a middleware computer system can be configured to indicate to the communication device that the driver can only view one order at a time. This option of only allowing a driver to view one order at a time helps to ensure that a driver will not change the sequence of orders determined by the scheduling system. Other options can be provided, such as allowing a driver to see the entire schedule but without the capability to alter the schedule, or allowing a driver to see the schedule with the capability to alter the schedule. Multiple options provide many advantages including the flexibility to use the proper option based upon a driver's amount of experience. For example, a less experienced driver may be provided an option of only seeing one order at a time. This may allow greater safety in the transportation of bulk fuel due to its hazardous nature. The option may be selected based upon other factors, such as having the option being a carrier-specific basis or driver-specific basis. A contract may stipulate which permission flag option is to be utilized.

Still further as another example, a Cadec unit (or its equivalent) can be extended in order to interact with a driver in the manner described herein as well as to provide data integrity validation operations for the driver's input and communications operations with the middleware computer system. The extension to a Cadec unit can be performed to minimize or eliminate the possibility of interfering with the safety and other DOT type operations associated with the normal operations of a Cadec unit. For example, a software API can be created to maintain the priority of the normal operations of the Cadec units with respect to the extension functionality.

A middleware computer system can include software to handle event notification. For example, a middleware computer system and a communication device can operate together to capture a large amount of logistics-related information. Because a middleware computer system can be configured to acquire logistics information in real-time or in near-real time, a middleware computer system can quickly and efficiently acquire the information.

With this real-time acquisition of data, a middleware computer can provide notifications on events so as to be of use in the real-time decision making process as opposed to mere batch reporting. As an example of the difference between reporting and event notification, a driver failure to report to work can be examined. A report with a driver's history and the number of times he/she failed to report to work can be a useful tool during an employee review; however, it can be more valuable to know in real-time that a driver has not reported for work before operations are effected. The information in middleware computer system can provide that information in real-time.

Event notification of a middleware computer system is not only informing the right person or system of an event, but also may include using the knowledge of that event to provide operations and decision makers with the information necessary to make the best decision possible at the proper time.

A system for event notification using a middleware computer system can be configured with the recognition that a carrier is one link in a larger supply chain because it can be difficult for any single member of the supply chain to understand the effect any single event may have on the rest of the supply chain. As an illustration, events with no particular relevance to a fuel transportation carrier may have greater relevance to the other member of the supply chain. To allow for different users to specify what is of relevance to them, an event notification system can be user definable and event driven by the members in the supply chain. When event “A” happens, a middleware computer system can send a notification including predefined data elements to supply chain member “B”. This approach allows a middleware computer system to be on alert for any single event or combination of events and inform supply chain members and other systems in the supply chain in sufficient time to be of assistance in the decision making process.

An event notification example can involve if a driver has not logged into his/her Cadec unit within a set time of his/her expected start of shift, then a message could be sent from a middleware computer system to scheduling and the driver's supervisor that the driver had not logged in and reported to work. This alerts the scheduler and the manager to take action.

As another illustration, a driver may be running late on his/her deliveries and customers scheduled for delivery by that driver later in the day are in danger of running out because the driver is running late. An event notification system could recognize that possibility by using established trip standards to calculate the new expected time of arrival and compare that to the run out time that had been established in the original schedule. If the run out time was earlier than the new expected delivery time, a middleware computer system could send a message to the scheduling center. The scheduling center could take the necessary action to avoid that run out by moving or rerouting loads.

As yet another illustration, if a driver logs out or ends his shift before completing all of the driver's assigned deliveries for that shift, a middleware computer system could send a message to the scheduling center and to the driver's supervisor regarding the loads remaining on that driver's shift to be delivered. The scheduling center could take the necessary action to move the loads to another driver for delivery.

Because of the multi-faceted approach of the supply chain, a user within the supply chain can select and customize the what, when, and how of event notification. A web-based user interface system can be used wherein a user can choose from a menu of available event categories. The user is then able to select rules from those categories with customizable parameters and conditions. Once the customized query string has been created, the user can specify the data elements returned, the priority of the event, and output method and destination. A customizable query string allows a user to construct a notification based on the occurrence of a single or chain of events.

An event notification system can be constructed to prevent a possible myriad of query options that can trigger false alarms due to incorrect setups, or that can even bring down a database because of an improperly constructed query. To prevent this, complexity limits can be established to the query building process. By using event categories and business-related rules, users (who are not database administrators or experts) can be allowed to define rules on how they choose to look at their business data. A complexity score for events allows a middleware computer system to ensure the system remains stable for the users. A query or call from the event system can be made subject to the data security model disclosed herein. Certain users can also define rules for their entire user group (e.g., for a user's associated group of drivers or billing personnel). By using a template, other users within the group can select a pre-constructed event to receive notification on.

As an example of a user-defined notification event, a user (e.g., a customer) can define criteria under which the user is to be notified that a particular event or situation has arisen. This is illustrated by a user defining that if the actual time for a truck's arrival at a destination is more than an hour outside the planned arrival time, then the user (or a person designated by the user) is notified of the discrepancy. The user can define additional criteria, such as different arrival time criteria on a per driver basis. The user can be provided with a user interface from which to select data items (e.g., arrival time) to be used as one or more conditions for triggering a notification. The user can then specify the values or parameters for the data items to designate when the notification event trigger is to occur.

There can be many methods of notification. An event information service can use multiple communication methods based not only on the priority level of the event, but also their real-time level of connectivity with a middleware computer system. Another notification method can involve a private instant messaging server and client system. An instant messaging (IM) system could allow the user to be notified near real-time as an event occurs without relying on checking e-mail. By using an instant messenger client, a middleware computer system avoids constructing another user interface since IM interfaces may already be available to users. By monitoring who is “logged in” to the messaging client, a middleware computer system can provide functionality of only notifying a user about a problem when they are on duty. This can allow a middleware computer system to avoid filling up e-mail accounts and IM boxes with messages for old events. Through the use of an “away” status of an IM client, users can have a middleware computer system reroute messages that would normally go to their IM client, a cell phone or pager.

A middleware computer system can support notification confirmations. As an illustration, for critical operational events, a middleware computer system can capture audit level data that the recipient received the event notification and when that action occurred. By providing this functionality, a middleware computer system offers not only event information and notification, but also accountability to the supply chain.

As other examples of the wide range of the disclosed systems and methods, the systems and methods may involve data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein. As an illustration, a communication device can be configured to run within a J2ME (Java 2 Micro Edition) environment. The methods can be implemented to run within a JVM (Java Virtual Machine). This can provide remote updating of the software operating on a communication device.

The systems'0 and methods'0 data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program. As an example, a system can also be configured to group orders into a shift data structure. As an illustration, the data structure can associate which drivers have been assigned to which shifts as well as what orders are contained within a shift. With such a data structure, the configured system can determine which shifts and drivers are impacted if an order is changed. For example, if the first order of a shift does not pass the system's validation rules, then the other orders in the shift that have been assigned to a driver can be handled so as to minimize the disruption of the schedule. The system may determine not to send the other orders in the driver's shift until the discrepancy with the first order has been fixed, such as by a dispatcher. This can help prevent erroneous order information being provided to the driver that could produce a retain situation. As another example, if an order is added to a driver's shift to be handled as the third order in the shift, the system can determine what orders are already in the shift and resequence the orders in order to prevent a discrepancy from arising. The data structure can be organized in many ways (e.g., such as a hierarchical data structure) in order to handle multiple orders as a group. Accordingly, the system can effectively determine what other orders are impacted due to a change to another order in the group.

A driver can use stick measurements to verify how much room there is in a customer's tank. The communication device can capture the stick readings (e.g., beginning stick reading of 5 and ending stick reading of 8) from a driver, and the communication device can perform in real-time the mathematical calculations based upon the stick readings to determine if the stick readings correspond to the order information (e.g., the amount that the communication device expects that a tank should have based upon the indicated order information is compared with the input stick readings). A notification is provided to the driver and/or to the server system if there is a discrepancy between the stick readings and the expected amount. The driver can then enter in real-time a reason (if one can be provided) for the discrepancy. In this way, discrepancy resolution has a higher chance of being corrected or addressed in real-time by the person who is in the best position to do so.

The systems and methods described herein may include communicating with a rack automation system, such as a rack automation system from Top Tech. A rack automation system is located at a fuel loading facility and monitors the dispensing of fuel from storage into a vehicle. Through its GPS capability, a vehicle's communication device can determine that it is sufficiently near to its pickup location and can send a message to the host server system that the vehicle is nearing the pickup location. The host server system can determine which order the vehicle is fulfilling. The rack automation system receives the order information from the host system along with the driver/vehicle identification. When the driver arrives at the fuel loading facility, the rack automation system already knows what the driver is to pick up because the host server system has provided the order and identification information. This minimizes delay between when the driver arrives at the destination and when the driver can begin loading fuel onto the vehicle. As an illustration, the driver can minimize fuel load setup time by avoiding the entering of order information since the rack automation system already has this information. The rack automation system can also report back whether any other problems exist with respect to fulfilling the order, such as the destination location does not have sufficient product in inventory to fulfill the order and that an alternate load terminal should be used. The rack automation system can also provide to the host server system information about the order, such as the bill of lading information. The host server system can transmit some or all of the information from the rack automation system so that the driver does not have to manually enter the information, such as the bill of lading information. The driver can verify that the transmitted information is correct. If the information from the rack automation system cannot be provided to the communication device, the host server can still use the rack automation system's information to later verify the information entered by the vehicle's driver.

Such capabilities help the overall fidelity of the data within the systems and methods since the data comes directly from the fuel provider to the fuel transporter. With the increased fidelity, errors related to fuel provider bills are reduced. Because the fuel providers already agree with the information (since they had provided it), the integrity of the data is improved and the fuel providers can be billed earlier.

The information provided to the rack automation system can be used to more efficiently address fuel allocation/allotment issues. Contracts with fuel providers (e.g., Marathon) may indicate that a certain amount of fuel can be purchased at a particular amount (i.e., the “allocation”). If a rack automation system is notified that a vehicle is nearing its destination (e.g., one-half hour away, five minutes away, etc.), then the rack automation system can indicate to the host server system whether there is an allocation problem, such as the fuel supplier is out of allocation at the intended load terminal. The allocation problem can then be addressed and/or resolved before the driver reaches the destination. Moreover, early notification of a pickup could reserve the fuel required to fulfill the order against the supplier's allocation. Such a reservation approach helps ensure that an adequate amount of fuel is available to fulfill the driver's order.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods'0 operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise; the phrase “exclusive or” may be used to indicate situation where only the disjunctive meaning may apply.

It is claimed:

1. A method for handling a petrochemical fuel order, comprising:
providing, over a network, fuel order data to a vehicle operator's communication device and displaying the received data to the fuel vehicle operator;
wherein the received fuel order data is for use in handling logistics related to picking up from a fuel loading facility and delivering petrochemical fuel to a fuel destination;
wherein a rack automation system is located at the fuel loading facility and monitors dispensing of fuel from storage into a vehicle;
receiving, over the network, from the rack automation system bill of lading information related to the fuel order;
receiving, over the network, fuel quantity delivered information from the vehicle operator's communication device;
wherein a customer has access over the network to the received bill of lading information and to the received fuel quantity delivered information.

2. The method of claim 1 further comprising:
receiving, over the network, from the vehicle operator's communications device snapshot information of the handling of the order by the vehicle operator;
wherein the customer has access over the network to the snapshot information.

3. The method of claim 1 further comprising:
receiving, over the network, delivery confirmation information from the vehicle operator's communication device;
wherein the customer has access over the network to the delivery confirmation information.

4. The method of claim 1, wherein a computer server accessible over the network uses fuel order processing rules to identify a data mismatch that occurs when sum of the gross fuel quantity provided by the vehicle operator's communication device does not correspond to gross fuel quantity specified by the bill of lading information.

5. The method of claim 4, wherein the fuel order processing rules are configured for use in determining integrity of bills sent to the customer for fulfillment of the fuel order by analyzing data provided over the network by the vehicle operator's communication device while fulfilling the fuel order.

6. The method of claim 5, wherein use by the server of order-related information from the rack automation system and the vehicle operator's communication device decreases customer order billing errors.

7. The method of claim 4, wherein the server is configured to process data from the rack automation system regarding a problem that a destination location does not have sufficient product in inventory to fulfill the order and that an alternate load terminal should be used.

8. The method of claim 1, wherein a timer is started about when the operator's vehicle has arrived at a fuel loading rack;
wherein about when the vehicle operator completes the fuel loading or entry of loading information into the communication device, the timer stops and the elapsed time is compared to an elapsed time criterion;
wherein if the elapsed time exceeds the criterion, then a notification is provided to the vehicle operator in order for a delay reason to be provided;
wherein depending upon the delay reason and an arrangement with the customer regarding a delay, a computer system bills the customer for the delay.

9. The method of claim 1, wherein the vehicle operator's communication device is configured to communicate over the network with a remote server and with the rack automation system over a wireless communications system located within the network;
wherein operative to notification from the vehicle operator's communication device that the operator's vehicle is within a pre-specified distance from the fuel loading facility, the server determines which order the vehicle is fulfilling;
wherein the server provides order data and vehicle operator or vehicle identification to the rack automation system;
wherein when the vehicle operator arrives at the fuel loading facility, the rack automation system handles the vehicle operator's order based upon the provided order data and vehicle operator or vehicle identification, thereby decreasing delay between when the vehicle operator arrives at the fuel pickup location and when the vehicle operator can begin loading fuel onto the vehicle.

10. The method of claim 9, wherein the server providing order data and vehicle operator or vehicle identification to the rack automation system comprises early notification of a pickup;
wherein the early notification results in reserving fuel required to fulfill the order against a supplier's allocation;
wherein the reserving ensures that an adequate amount of fuel is available to fulfill the vehicle operator's order.

11. The method of claim 1, wherein the vehicle operator's communication device communicates with a remote server and with the rack automation system over a wireless communications system located within the network;
wherein the communication device is configured for accessing data from a global positioning satellite (GPS) location system in order to ascertain real-time position of the vehicle operator's vehicle;
wherein the communication device uses the GPS data to determine whether a vehicle operator's vehicle is within a pre-specified distance from the fuel loading facility;
wherein operative to the GPS data indicating that the vehicle operator's vehicle is within a pre-specified distance from the fuel loading facility, the communication device sends a notification to the server that the vehicle is nearing the pickup location;
wherein operative to the notification from the communication device, the server determines which order the vehicle is fulfilling;
wherein the server provides order data and vehicle operator or vehicle identification to the rack automation system;
wherein when the vehicle operator arrives at the fuel loading facility, the rack automation system handles the vehicle operator's order based upon the provided order data and vehicle operator or vehicle identification, thereby decreasing delay between when the vehicle operator arrives at the fuel pickup location and when the vehicle operator can begin loading fuel onto the vehicle.

12. The method of claim 11, wherein the server receives from the rack automation system whether any problems exist with respect to fulfilling the order;
wherein the server processes data from the rack automation system regarding a problem that a destination location does not have sufficient product in inventory to fulfill the order and that an alternate load terminal should be used;
wherein the server receives from the rack automation system bill of lading information related to a fuel order;
wherein the server transmits information received from the rack automation system in order to pre-populate information in data fields that a vehicle operator would have to manually enter through the communication device, thereby decreasing amount of manual entry by the vehicle operator;
wherein the transmitted information includes bill of lading information provided by the rack automation system.

13. The method of claim 1, wherein the communication device is configured for accessing data from a global positioning satellite (GPS) location system in order to ascertain real-time position of the vehicle operator's vehicle; wherein the GPS accessed data is for use in determining whether the vehicle operator is in compliance with scheduling instructions based upon whether the current location of the vehicle matches the location expected in the scheduling instructions.

14. The method of claim 4, wherein the server uses information provided by the rack automation system to verify information provided by the communication device related to an order.

15. The method of claim 14, wherein use of order-related information from the rack automation system by the server and the communication device decreases order billing errors.

16. The method of claim 1, wherein the network includes one or more networks; wherein the one or more networks include a cellular communication network, a satellite communication network, and a wireless communication network.

17. The method of claim 1, wherein security rules are used to determine whether a customer has access over the network to the received bill of lading information and to the received fuel quantity delivered information.

18. The method of claim 1, wherein a database is used to store the received bill of lading information and the received fuel quantity delivered information.

19. The method of claim 1, wherein fuel order processing rules are configured for use in identifying data mismatches that occur with respect to data provided from the vehicle operator's communication device.

20. A system for handling a petrochemical fuel order, comprising:
a data interface to provide, over a network, fuel order data to a vehicle operator's communication device and displaying the received data to the fuel vehicle operator;
wherein the received fuel order data is for use in handling logistics related to picking up from a fuel loading facility and delivering petrochemical fuel to a fuel destination;
wherein a rack automation system is located at the fuel loading facility and monitors dispensing of fuel from storage into a vehicle;
a data interface to receive, over the network, from the rack automation system bill of lading information related to the fuel order;
a data interface to receive, over the network, fuel quantity delivered information from the vehicle operator's communication device;
wherein a customer has access over the network to the received bill of lading information and to the received fuel quantity delivered information.
